(19) United States
(12) Patent Application Publication
(10) Pub. No.: US 2005/0066112 A1
(43) Pub. Date: Mar. 24, 2005

(54) Data read/write control system and data read/write control method

(75) Inventors: Takeshi Osakabe, Kanagawa (JP); Hiroyuki Kawaguchi, Kanagawa (JP); Yoshitaka Ueda, Kanagawa (JP); Shuji Takahashi, Kanagawa (JP)

Correspondence Address: MCGINN & GIBB, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 10/942,023

(22) Filed: Sep. 16, 2004

(30) Foreign Application Priority Data
Sep. 19, 2003 (JP) 2003-327160

(51) Int. Cl. G06F 12/00

(52) U.S. Cl. 711/103; 711/170

(57) ABSTRACT

A data read/write control system includes memory divided into a plurality of blocks, a write unit, and a read unit. When writing data to one block of the plurality of blocks, the write unit compares a size of the data with a capacity of a blank area of the block. If the size of the data is larger, the write unit erases all data stored in the block and sequentially writes the data to the block from top or end. If, on the other hand, the size of the data is smaller, the write unit sequentially writes the data to the block from an area next to an area where data is stored. When reading data from the block, the read unit sequentially searches the block from top or end to find an area where data is written last, and reads the data stored in the area.

### BACKGROUND OF THE INVENTION

1. Field of the Invention

The present invention relates to a system and method of controlling reading and writing of data and, particularly, to a system and method of controlling reading and writing of data in flash memory.

2. Description of Related Art

Recent electronic devices include both flash memory and EEPROM. Japanese Unexamined Patent Application Publication No. 2002-334024 describes this kind of electronic device. Flash memory can be written with new data only after a block of data is erased. Thus, such electronic devices use either flash memory or EEPROM according to contents of data to be stored.

However, the electronic devices including both flash memory and EEPROM cost high. A technique to use flash memory like EEPROM has therefore been anticipated.

### SUMMARY OF THE INVENTION

In view of the foregoing, an object of the present invention is to provide a data read/write control system capable of rewriting flash memory like EEPROM. Another object of the present invention is to provide a data read/write control system capable of rewriting flash memory without occupying CPU resource.

To these ends, according to a first aspect of the present invention, there is provided a data read/write control system including memory, a write unit, and a read unit. The memory is divided into a plurality of blocks. When writing data to one block of the plurality of blocks, the write unit compares a size of the data with a capacity of a blank area of the block. If the size of the data is larger, the write unit erases all data stored in the block and sequentially writes the data to the block from top or end. If, on the other hand, the size of the data is smaller, the write unit sequentially writes the data to the block from an area next to an area where data is stored. When reading data from the block, the read unit sequentially searches the block from top or end to find an area where data is written last, and reads the data stored in the area.

According to a second aspect of the present invention, there is provided the data read/write control system of the first aspect, wherein, in writing data to the block, the write unit further writes control data including information on reading of the data before or after the data.

According to a third aspect of the present invention, there is provided a data read/write control system including memory, a control data storage unit, a write unit, and a read unit. The memory is divided into a plurality of blocks. The control data storage unit stores control data including information on reading of data stored in one block of the plurality of blocks. When writing data to one block of the plurality of blocks, a write unit compares a size of the data with a capacity of a blank area of the block. If the size of the data is larger, the write unit erases all data stored in the block, sequentially writes the data to the block from top or end, and further writes control data of the written data to the control data storage unit. If, on the other hand, the size of the data is smaller, the write unit sequentially writes the data to the block from an area next to an area where data is stored and further writes control data of the written data to the control data storage unit. When reading data from the block, the read unit sequentially searches the block for an area where data is written last based on the control data stored in the control data storage unit and reads the data stored in the area.

According to a fourth aspect of the present invention, there is provided the data read/write control system of one of the first to third aspects, further including a switch unit for, when the write unit writes data to a block, switching a block from which the read unit is to read data to the block where the data is written.

According to a fifth aspect of the present invention, there is provided the data read/write control system of one of the first to fourth aspects, wherein, if a block becomes full with data, the write unit copies latest data written to the block to a different block and sets a flag indicating that the different block is a valid block for writing and reading data.

According to a sixth aspect of the present invention, there is provided the data read/write control system of one of the first to fifth aspects, wherein the control data includes a size of each data written to the block and/or a pointer indicating an address of data written next to each data.

According to a seventh aspect of the present invention, there is provided the data read/write control system of one of the first to fifth aspects, wherein the control data includes an address of data written last to the block.

According to an eighth aspect of the present invention, there is provided the data read/write control system of one of the first to seventh aspects, wherein the write unit verifies the block after writing data to the block.

According to a ninth aspect of the present invention, there is provided the data read/write control system of the eighth aspect, wherein, if the verification fails, the write unit overwrites data where the verification fails with data indicating error data.

According to a tenth aspect of the present invention, there is provided a data read/write control system including a temporary storage unit, a central processing unit, memory, and a control unit. The temporary storage unit temporarily stores data. The central processing unit writes data to the temporary storage unit. The memory is divided into a plurality of blocks, The includes a write unit and a read unit. When writing data stored in the temporary storage unit to one block of the plurality of blocks, the write unit compares a size of the data with a capacity of a blank area of the block. If the size of the data is larger, the write unit erases all data stored in the block and sequentially writes the data to the block from top or end. If, on the other hand, the size of the data is smaller, the write unit sequentially writes the data to the block from an area next to an area where data is stored. When reading data from the block, the read unit sequentially searches the block from top or end to find an area where data is written last, and then reads the data stored in the area.

According to an eleventh aspect of the present invention, there is provided the data read/write control system of the tenth aspect, wherein, each time data is written to the temporary storage unit, the write unit writes the data to the block.

According to a twelfth aspect of the present invention, there is provided the data read/write control system of the tenth or eleventh aspect, wherein the write unit writes data stored in the temporary storage unit to the block upon satisfaction of a predetermined condition.

According to a thirteenth aspect of the present invention, there is provided a data read/write control method for controlling data writing and reading in memory divided into a plurality of blocks. The method includes writing data to one block of the plurality of blocks, and reading data from the block. In writing data, the method compares a size of the data with a capacity of a blank area of the block. If the size of the data is larger, the method erases all data stored in the block and sequentially writes the data to the block from top or end. If, on the other hand, the size of the data is smaller, the method sequentially writes the data to the block from an area next to an area where data is stored. In reading data, the method sequentially searches the block from top or end for an area where data is written last, and then reads the data stored in the area.

According to a fourteenth aspect of the present invention, there is provided the data read/write control method of the thirteenth aspect, wherein, in writing data to the block, control data including information on reading of the data is written before or after the data.

According to a fifteenth aspect of the present invention, there is provided a data read/write control method for controlling data writing and reading in memory divided into a plurality of blocks and a control data storage unit for storing control data including information on reading of data stored in one block of the plurality of blocks. The method includes writing data to one block of the plurality of blocks and reading data from the block. In writing data, the method compares a size of the data with a capacity of a blank area of the block. If the size of the data is larger, the method erases all data stored in the block, sequentially writes the data to the block from top or end, and further writes control data of the written data to the control data storage unit. If, on the other hand, the size of the data is smaller, the method sequentially writes the data to the block from an area next to an area where data is stored, and further writes control data of the written data to the control data storage unit. In reading data from the block, the method sequentially searches the block for an area where data is written last based on the control data stored in the control data storage unit, and reads the data stored in the area.

According to a sixteenth aspect of the present invention, there is provided the data read/write control method of one of the thirteenth to fifteenth aspects, further including predetermining a block where data is to be read, and, if data is written to a block different from the predetermined block, swapping the block where data is written and the block where data is to be read to avoid change in the block where data is to be read.

According to a seventeenth aspect of the present invention, there is provided the data read/write control method of one of the thirteenth to sixteenth aspects, further including, if a block becomes full with data, copying latest data written to the block to a different block, and setting a flag indicating that the different block is a valid block for writing and reading data.

According to an eighteenth aspect of the present invention, there is provided the data read/write control method of one of the thirteenth to seventeenth aspects, wherein the control data includes a size of each data written to the block and/or a pointer indicating an address of data written next to each data.

According to a nineteenth aspect of the present invention, there is provided the data read/write control method of one of the thirteenth to seventeenth aspects, wherein the control data includes an address of data written last to the block.

According to a twentieth aspect of the present invention, there is provided the data read/write control method of one of the thirteenth to nineteenth aspects, further including verifying the block after writing data to the block.

According to a twenty-first aspect of the present invention, there is provided the data read/write control method of the twentieth aspect, further including, if the verification fails, overwriting data where the verification fails with data indicating error data.

According to a twenty-second aspect of the present invention, there is provided a data read/write control method for controlling data writing and reading in a temporary storage unit for temporarily storing data and memory divided into a plurality of blocks. The method includes writing data to the temporary storage unit, writing data stored in the temporary storage unit to one block of the plurality of blocks, and reading data from the block. In writing data to one block of the plurality of blocks, the method compares a size of the data with a capacity of a blank area of the block. If the size of the data is larger, the method erases all data stored in the block and sequentially writes the data to the block from top or end. If, on the other hand, the size of the data is smaller, the method sequentially writes the data to the block from an area next to an area where data is stored. In reading data from the block, the method sequentially searches the block from top or end to find an area where data is written last, and then reads the data stored in the area.

According to a twenty-third aspect of the present invention, there is provided the data read/write control method of the twenty-second aspect, wherein, in writing data to one block of the plurality of blocks, data is written to the block each time the data is written to the temporary storage unit.

According to a twenty-fourth aspect of the present invention, there is provided the data read/write control method of the twenty-second or twenty-third aspect, wherein, in writing data to one block of the plurality of blocks, data stored in the temporary storage unit is written to the block upon satisfaction of a predetermined condition.

According to a twenty-fifth aspect of the present invention, there is provided computer-readable media tangibly embodying a program of instructions executable by a computer to perform a method of controlling data writing and reading in a data read/write control system having memory divided into a plurality of blocks. The method includes writing data to one block of the plurality of blocks and reading data from the block. In writing data, the method compares a size of the data with a capacity of a blank area of the block, and, if the size of the data is larger, erases all data stored in the block and sequentially writes the data to the block from top or end; on the other hand, if the size of the data is smaller, the method sequentially writes the data to the block from an area next to an area where data is stored. In reading data, the method sequentially searches the block from top or end for an area where data is written last, and then reads the data stored in the area.

According to a twenty-sixth aspect of the present invention, there is provided the computer-readable media of the twenty-fifth aspect, wherein in writing data to the block, control data including information on reading of the data is written before or after the data.

According to a twenty-seventh aspect of the present invention, there is provided computer-readable media tangibly embodying a program of instructions executable by a computer to perform a method of controlling data writing and reading in a data read/write control system having memory divided into a plurality of blocks and a control data storage unit for storing control data including information on reading of data stored in one block of the plurality of blocks. The method includes writing data to one block of the plurality of blocks and reading data from the block. In writing data, the method compares a size of the data with a capacity of a blank area of the block. If the size of the data is larger, the method erases all data stored in the block, sequentially writes the data to the block from top or end, and further writes control data of the written data to the control data storage unit. If, on the other hand, the size of the data is smaller, the method sequentially writes the data to the block from an area next to an area where data is stored, and further writes control data of the written data to the control data storage unit. In reading data from the block, the method sequentially searches the block for an area where data is written last based on the control data stored in the control data storage unit, and then reads the data stored in the area.

According to a twenty-eighth aspect of the present invention, there is provided the computer-readable media of one of the twenty-fifth to twenty-seventh aspects, wherein the method further includes, upon writing of data to a block, switching a block from which the read unit is to read data to the block where the data is written.

According to a twenty-ninth aspect of the present invention, there is provided the computer-readable media of one of the twenty-fifth to twenty-eighth aspects, wherein the method further includes, if a block becomes full with data, copying latest data written to the block to a different block, and setting a flag indicating that the different block is a valid block for writing and reading data.

According to a thirtieth aspect of the present invention, there is provided the computer-readable media of one of the twenty-fifth to twenty-ninth aspects, wherein the control data includes a size of each data written to the block and/or a pointer indicating an address of data written next to each data.

According to a thirty-first aspect of the present invention, there is provided the computer-readable media of one of the twenty-fifth to twenty-ninth aspects, wherein the control data includes an address of data written last to the block.

According to a thirty-second aspect of the present invention, there is provided the computer-readable media of one of the twenty-fifth the thirty-first aspects, wherein the method further includes verifying the block after writing data to the block.

According to a thirty-third aspect of the present invention, there is provided the computer-readable media of the thirty-second aspect, wherein the method further includes, if the verification fails, overwriting data where the verification fails with data indicating error data.

According to a thirty-fourth aspect of the present invention, there is provided computer-readable media tangibly embodying a program of instructions executable by a computer to perform a method of controlling data writing and reading in a data read/write control system having a temporary storage unit for temporarily storing data and memory divided into a plurality of blocks. The method includes writing data to the temporary storage unit, writing data stored in the temporary storage unit to one block of the plurality of blocks, and reading data from the block. In writing data to one block of the plurality of blocks, the method compares a size of the data with a capacity of a blank area of the block. If the size of the data is larger, the method erases all data stored in the block and sequentially writes the data to the block from top or end. If, on the other hand, the size of the data is smaller, the method sequentially writes the data to the block from an area next to an area where data is stored. In reading data from the block, the method sequentially searches the block from top or end for an area where data is written last, and then reads the data stored in the area.

According to a thirty-fifth aspect of the present invention, there is provided the computer-readable media of the thirty-fourth aspect, wherein, in writing data to one block of the plurality of blocks, data is written to the block each time data is written to the temporary storage unit.

According to a thirty-sixth aspect of the present invention, there is provided the computer-readable media of the thirty-fourth or thirty-fifth aspect, in writing data to one block of the plurality of blocks, data stored in the temporary storage unit is written to the block upon satisfaction of a predetermined condition.

The present invention described above allows using flash memory like EEPROM. It further allows rewriting flash memory without occupying CPU resource.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a block diagram of a specific embodiment of the present invention.

FIG. 2 is a block diagram of flash memory according to a first embodiment of the invention.

FIG. 3 is a flowchart of a data writing process according to the first embodiment of the invention.

FIG. 4 is a flowchart of a data reading process according to the first embodiment of the invention.

FIG. 5 is a block diagram of flash memory according to a second embodiment of the invention.

FIG. 6 is a flowchart of a data writing process according to the second embodiment of the invention.

FIG. 7 is a flowchart of a data reading process according to the second embodiment of the invention.

FIG. 8 is a block diagram of flash memory according to a third embodiment of the invention.

FIG. 9 is a flowchart of a data writing process according to the third embodiment of the invention.

FIGS. 10A and 10B are diagrams showing the transition of a block according to the third embodiment of the invention.

FIG. 11 is a flowchart of a data reading process according to the third embodiment of the invention.

FIG. 12 is a block diagram of a fourth embodiment of the invention.

FIG. 13 is a block diagram of flash memory according to the fourth embodiment of the invention.

FIG. 14 is a flowchart of a data writing process according to the fourth embodiment of the invention.

FIGS. 15A and 15B are diagrams showing the transition of blocks according to the fourth embodiment of the invention.

FIG. 16 is a flowchart of a data reading process according to the fourth embodiment of the invention.

FIG. 17 is a block diagram of a block according to a fifth embodiment of the invention.

FIGS. 18A to 18D are diagrams showing the transition of blocks according to the fifth embodiment of the invention.

FIG. 19 is a flowchart of a data writing process according to the fifth embodiment of the invention.

FIG. 20 is a flowchart of a data reading process according to the fifth embodiment of the invention.

FIG. 21 is a flowchart of a data writing process according to a sixth embodiment of the invention.

FIGS. 22A to 22C are diagrams showing the transition of a block according to the sixth embodiment of the invention.

FIG. 23 is a flowchart of a data reading process according to the sixth embodiment of the invention.

FIG. 24 is a flowchart of a data writing process according to a seventh embodiment of the invention.

FIG. 25 is a block diagram of flash memory according to an eighth embodiment of the invention.

FIG. 26 is a flowchart of a data writing process according to the eighth embodiment of the invention.

FIG. 27 is a diagram showing the transition of blocks according to the eighth embodiment of the invention.

FIG. 28 is a block diagram to explain a ninth embodiment of the invention.

FIG. 29 is a block diagram to explain a tenth embodiment of the invention.

FIG. 30 is a block diagram to explain an eleventh embodiment of the invention.

FIG. 31 is a block diagram to explain a twelfth embodiment of the invention.

FIG. 32 is a block diagram to explain a thirteenth embodiment of the invention.

FIG. 33 is a block diagram to explain swap in the invention.

### DESCRIPTION OF PREFERRED EMBODIMENTS

Embodiment 1

A first embodiment of the present invention is explained hereinafter. The first embodiment describes a method of writing new user data and the size of the new user data to flash memory. This method allows flash memory to be used like EEPROM.

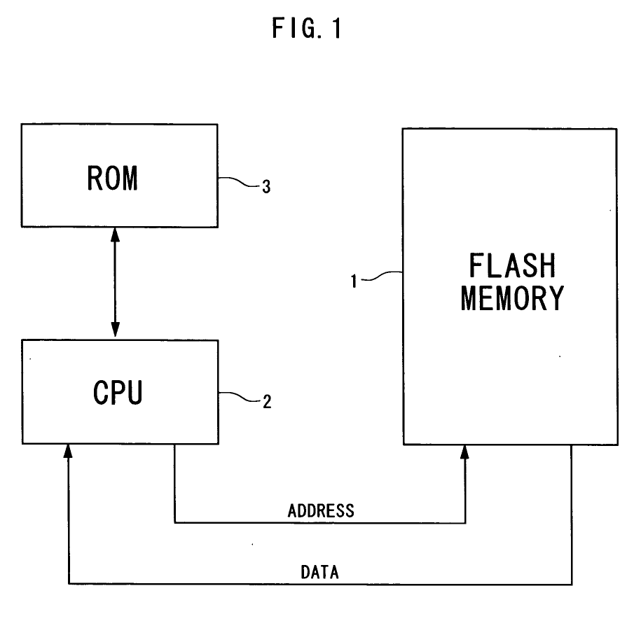

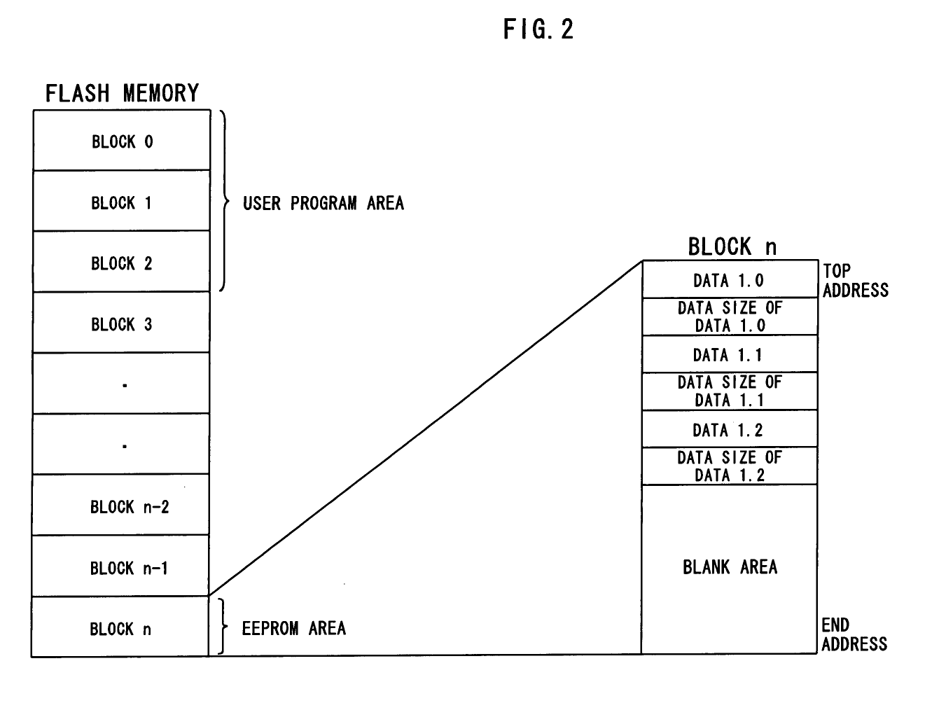

FIG. 1 shows the structure of the first embodiment. FIG. 2 shows the structure of flash memory.

Flash memory 1 shown in FIG. 1 is divided into a plurality of memory areas from Block 0 to n, as shown in FIG. 2. A user program area and an EEPROM area are predefined in Blocks 0 to n. The user program area stores various data. The EEPROM area is used as an alternative for EEPROM. This embodiment uses Block n as the EEPROM area.

A CPU 2 in FIG. 1 writes user data and the size of the user data to Block n, which is the EEPROM area of the flash memory 1. The user data and the user data size are sequentially written in this order from the top address of Block n. Though the CPU 2 writes four bytes of data each time in this embodiment, the unit of data is not limited to four bytes.

When writing new user data to Block n, the CPU 2 searches Block n in every four bytes sequentially from the end address to find a non-blank address. Retrieving the non-blank address, the CPU 2 determines whether the size of the new user data is smaller than the capacity of the blank area of Block n. At the same time, the CPU 2 determines whether the address determined as a blank is the top address of Block n by checking the presence of an address immediately preceding the address determined as a blank, which is, an address located four bytes before.

If the CPU 2 determines that the size of the new user data is smaller than the capacity of the blank area of Block n, it writes the new user data to the address next to the non-blank address. The CPU 2 further writes the size of the new user data to the address next to the address where the new user data is written.

If, on the other hand, the CPU 2 determines that the size of the new user data is larger than the capacity of the blank area of Block n, it erases all the data stored in Block n.

When reading the user data stored in Block n, the CPU 2 searches Block n sequentially from the end address to find a non-blank address. Retrieving the non-blank address, the CPU 2 calculates the address that stores user data based on the user data size stored in the retrieved address. The CPU 2 then reads the user data stored in the calculated address.

ROM 3 in FIG. 1 stores a program for the CPU 2 to execute to control the flash memory 1. The CPU 2 operates according to the program.

A method of writing user data in the above system is explained below.

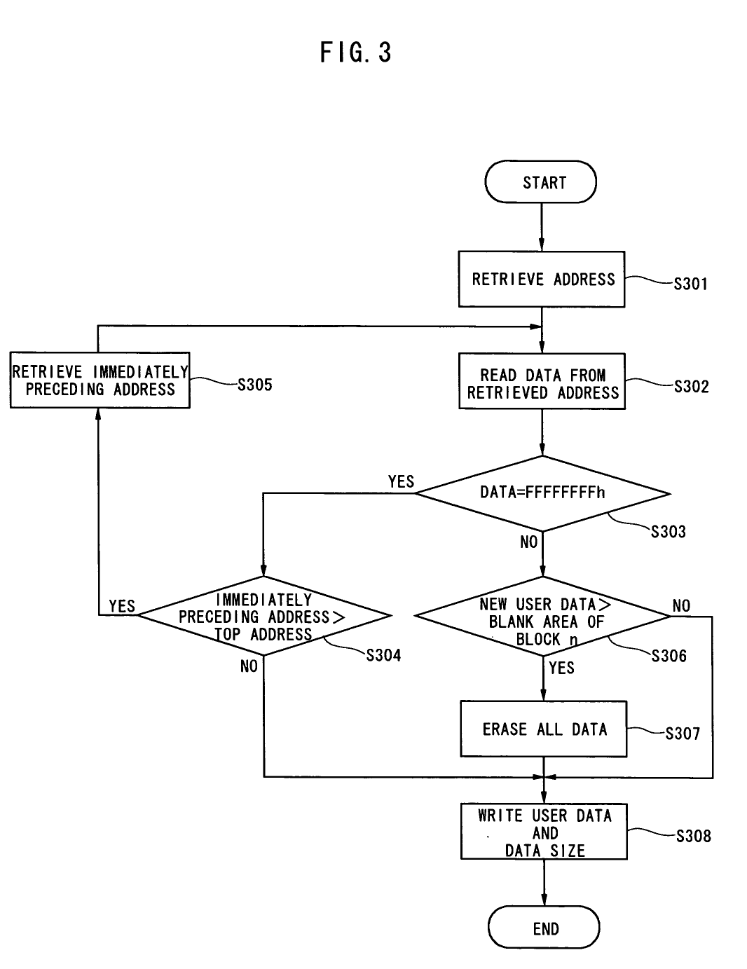

FIG. 3 is a flowchart showing the operation of the CPU 2 to write user data to the flash memory 1 according to the first embodiment. First, the CPU 2 searches Block n for the end address (S301). Retrieving the end address, the CPU 2 reads data stored in the end address (S302). Then, the CPU 2 determines whether the read data is blank or not (S303).

If the CPU 2 determines the read data to be blank, it then determines whether an address immediately preceding the address determined as a blank exists or not (S304). Since the unit of data written to the memory in this embodiment is four bytes, the CPU 2 checks the presence of an address located four bytes before.

If the CPU 2 determines that the immediately preceding address exists, it retrieves this address (S305), and the process returns to Step S302. The CPU 2 repeats Steps S302 to S305 until it determines in S303 that the read data is not blank.

If the CPU 2 determines in S303 that the read data is not blank, it then determines whether the size of the new user data is larger than the capacity of the blank area of Block n (S306).

If the CPU 2 determines that the size of the new user data is larger than the capacity of the blank area of Block n, it erases all the data stored in Block n (S307). After erasing all the data, the CPU 2 writes the new user data to the top address and further writes the size of the new user data to the address next to the top address (S308).

If, on the contrary, the CPU 2 determines that the size of the new user data is smaller than the capacity of the blank area of Block n, the operation of the CPU 2 proceeds to Step S308. The CPU 2 writes the new user data to the address next to the address determined to be non-blank in Step S303. The CPU 2 further writes the size of the new user data to the address next to the address where the new user data is written.

If the CPU 2 determines in Step S304 that the immediately preceding address does not exist, it determines that Block n is totally blank and the process proceeds to Step S308.

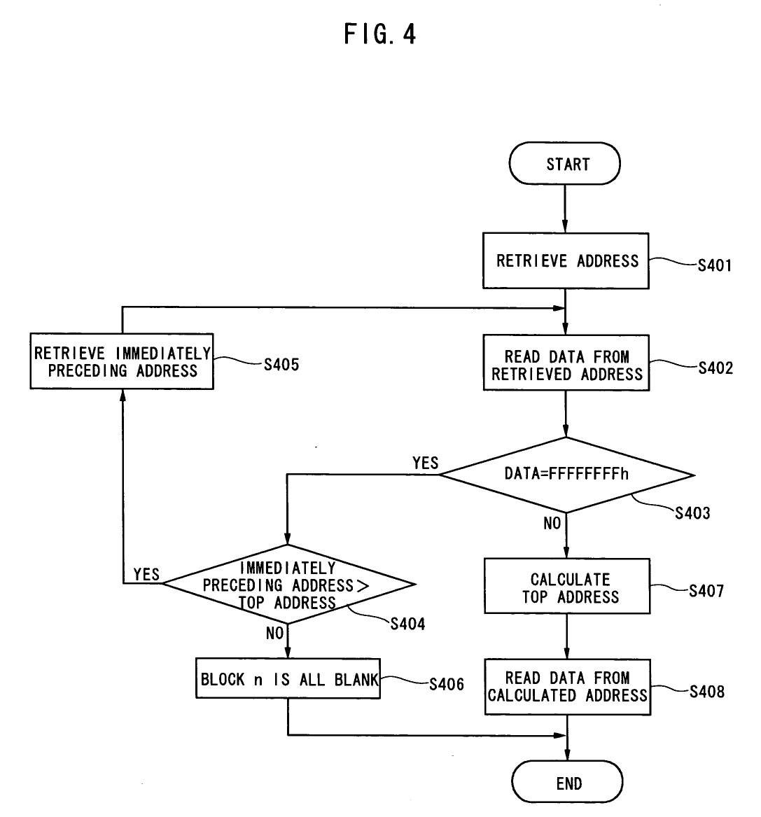

A method of reading the user data written by the above method is explained below. FIG. 4 is a flowchart showing the operation of the CPU 2 to read user data from the flash memory 1 according to the first embodiment.

The CPU 2 first retrieves the end address of Block n (S401). The CPU 2 then reads data stored in the end address (S402). After that, the CPU 2 determines whether the read data is blank or not (S403).

If the CPU 2 determines that the read data is blank, it then determines whether an immediately preceding address, which is an address located four bytes before, exists or not (S404).

If the CPU 2 determines that the immediately preceding address exists, it retrieves this address (S405), and the process returns to Step S402. If, on the contrary, the CPU 2 determines that the immediately preceding address does not exist, it determines that Block n is totally blank and ends the read process (S406).

If, on the other hand, the CPU 2 determines in Step S403 that the read data is not blank, it calculates a top address that stores the latest user data based on the user data size stored in the non-blank address (S407). The CPU 2 then reads the user data stored in the calculated address (S408).

As described in the foregoing, the above system stores the size of each user data together with the user data, which allows storing variable-length data.

Since this embodiment writes new user data sequentially from the top address, it is suitable for the application that requires only one kind of the latest data.

Embodiment 2

A second embodiment of the present invention is explained hereinafter. Though the first embodiment describes the method of storing new user data and the size of the new user data sequentially from the top address of a block, the second embodiment describes the method of storing new user data and the size of the user data sequentially from the end address of a block.

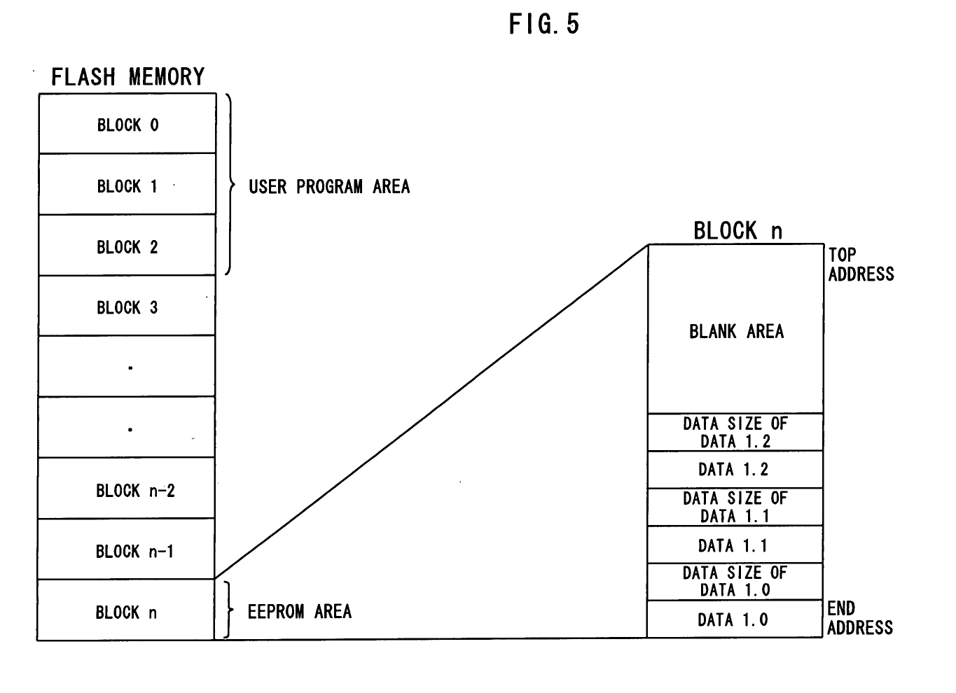

The structure of the second embodiment is the same as that of the first embodiment shown in FIG. 1. FIG. 5 is a block diagram of the flash memory 1 according to the second embodiment.

The flash memory 1 is divided into a plurality of memory areas from Block 0 to n, as shown in FIG. 5. A user program area and an EEPROM area are predefined in Blocks 0 to n. The user program area stores various data. The EEPROM area is used as an alternative for EEPROM. The second embodiment also uses Block n as the EEPROM area.

The CPU 2 writes user data and the size of the user data to Block n, which is the EEPROM area of the flash memory 1. The user data and the user data size are sequentially written in this order from the end address of Block n. Though the CPU 2 writes four bytes of data each time in this embodiment, the unit of data is not limited to four bytes.

When writing new user data to Block n, the CPU 2 searches Block n in every four bytes sequentially from the top address to find a non-blank address. Retrieving the non-blank address, the CPU 2 determines whether the size of the new user data is smaller than the capacity of the blank area of Block n.

If the CPU 2 determines that the size of the new user data is smaller than the capacity of the blank area of Block n, it writes the new user data to the address located the size of the new user data before the non-blank address. The CPU 2 further writes the size of the new user data to the address prior to the address where the new user data is written. If, on the other hand, the CPU 2 determines that the size of the new user data is larger than the capacity of the blank area of Block n, it erases all the data stored in Block n.

When reading user data stored in Block n, the CPU 2 searches Block n in every four bytes sequentially from the top address to find a non-blank address. The CPU 2 then calculates an address that stores user data based on the user data size stored in the retrieved non-blank address and reads the user data stored in the calculated address.

A method of writing user data according to the second embodiment is explained below.

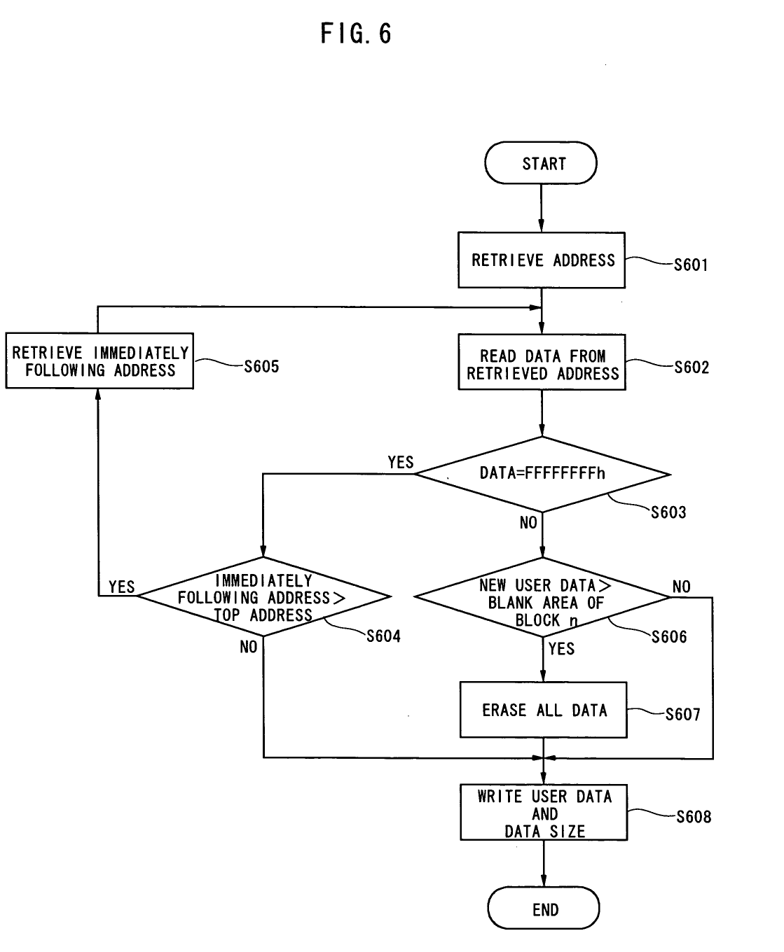

FIG. 6 is a flowchart showing the operation of the CPU 2 to write new user data to the flash memory 1. First, the CPU 2 searches Block n for the top address of Block n (S601). Retrieving the top address, the CPU 2 reads data stored in the top address (S602). Then, the CPU 2 determines whether the read data is blank or not (S603).

If the CPU 2 determines the top address to be blank, it then determines whether an address immediately following the address determined as a blank exists or not (S604). Since the unit of data written to the memory in this embodiment is four bytes, the CPU 2 checks the presence of an address located four bytes after.

If the CPU 2 determines that the immediately following address exists, it retrieves this address (S605), and the process returns to Step S602. The CPU 2 repeats Steps S602 to S605 until it determines in Step S603 that the read data is not blank.

If the CPU 2 determines in Step S603 that the read data is not blank, it then determines whether the size of the new user data is larger than the capacity of the blank area of Block n (S606).

If the CPU 2 determines that the size of the new user data is larger than the capacity of the blank area of Block n, it erases all the data stored in Block n (S607). After erasing the data, the CPU 2 writes the new user data to the address located the size of the new user data before the end address and further writes the size of the new user data to the address prior to the address where the new user data is written (S608).

If, on the contrary, the CPU 2 determines in Step 606 that the size of the new user data is smaller than the capacity of the blank area of Block n, the operation of the CPU 2 proceeds to Step S608. The CPU 2 writes the new user data to the address located the size of the new user data before the address determined to be non-blank in Step S603. The CPU 2 further writes the size of the new user data to the address prior to the address where the new user data is written.

If the CPU 2 determines in Step S604 that the immediately following address does not exist, it determines that Block n is totally blank and the process proceeds to Step S608 to write the new user data to the address located the size of the new user data before the end address and further write the size of the new user data to the address prior to the address where the new user data is written.

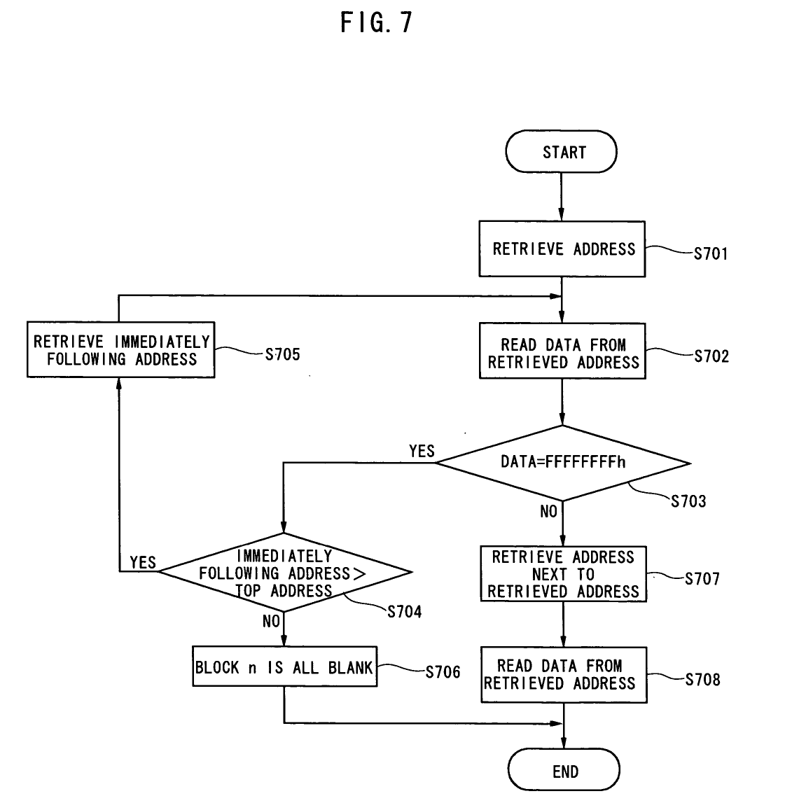

A method of reading the user data written by the above method is explained below. FIG. 7 is a flowchart showing the operation of the CPU 2 to read user data from the flash memory 1 according to the second embodiment.

The CPU 2 first retrieves the top address of Block n (S701). The CPU 2 then reads data stored in the top address (S702). After that, the CPU 2 determines whether the read data is blank or not (S703).

If the CPU 2 determines that the read data is blank, it then determines whether an immediately following address exists or not (S704)

If the CPU 2 determines that the immediately following address exists, it retrieves this address (S705), and the process returns to Step S702. If, on the other contrary, the CPU 2 determines that the immediately preceding address does not exist, it determines that Block n is totally blank and ends the read process (S706).

If, on the other hand, the CPU 2 determines in Step S703 that the read data is not blank, it retrieves the next address since the data size is written to that address (S707). The CPU 2 then reads the user data stored in the retrieved address (S708).

The above system allows quickly reading user data from the flash memory storing a large number of user data in the application that requires only one latest data.

Embodiment 3

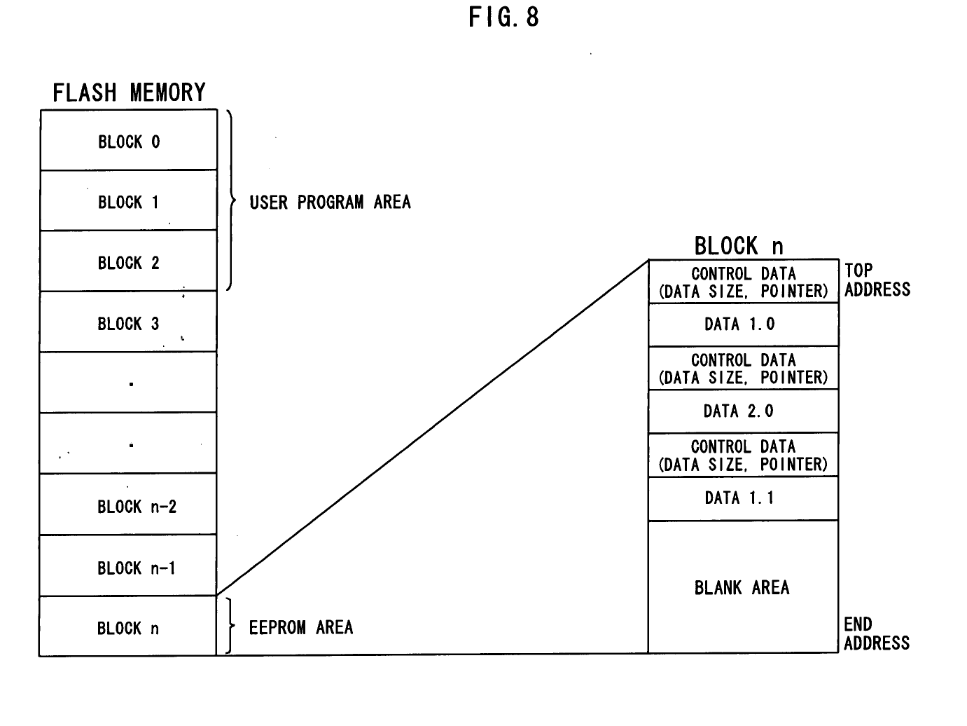

A third embodiment of the present invention is explained hereinafter. The structure of the third embodiment is the same as that of the first embodiment shown in FIG. 1. FIG. 8 is a block diagram of the flash memory 1 according to the third embodiment.

The flash memory 1 is divided into a plurality of memory areas from Block 0 to n, as shown in FIG. 8. A user program area and an EEPROM area are predefined in the Blocks 0 to n. The user program area stores various data. The EEPROM area is used as an alternative for EEPROM. The third embodiment also uses Block n as the EEPROM area.

The CPU 2 writes control data consisting of the size and pointer of new user data and user data sequentially in this order to Block n from the top address. The pointer is controlled by the type of data, which is, by the data of each application. The pointer of user data of each application is written with an address of the next user data. The pointer of the last user data of each application is written with nothing and left blank. Each application retains a top user data address, which is the address of top user data of the application in Block n.

Though the CPU 2 writes four bytes of data each time in this embodiment, the unit of data is not limited to four bytes.

When writing new user data to Block n, the CPU 2 searches Block n sequentially from the top address to find a blank address. If the CPU 2 finds a non-blank address, it checks the presence of the next address in order to determine whether this address is the last address or not.

When reading user data stored in Block n, the CPU 2 searches Block n sequentially from the top user data address retained in the application to find an address where pointer data is blank.

A method of writing user data according to the third embodiment is explained below.

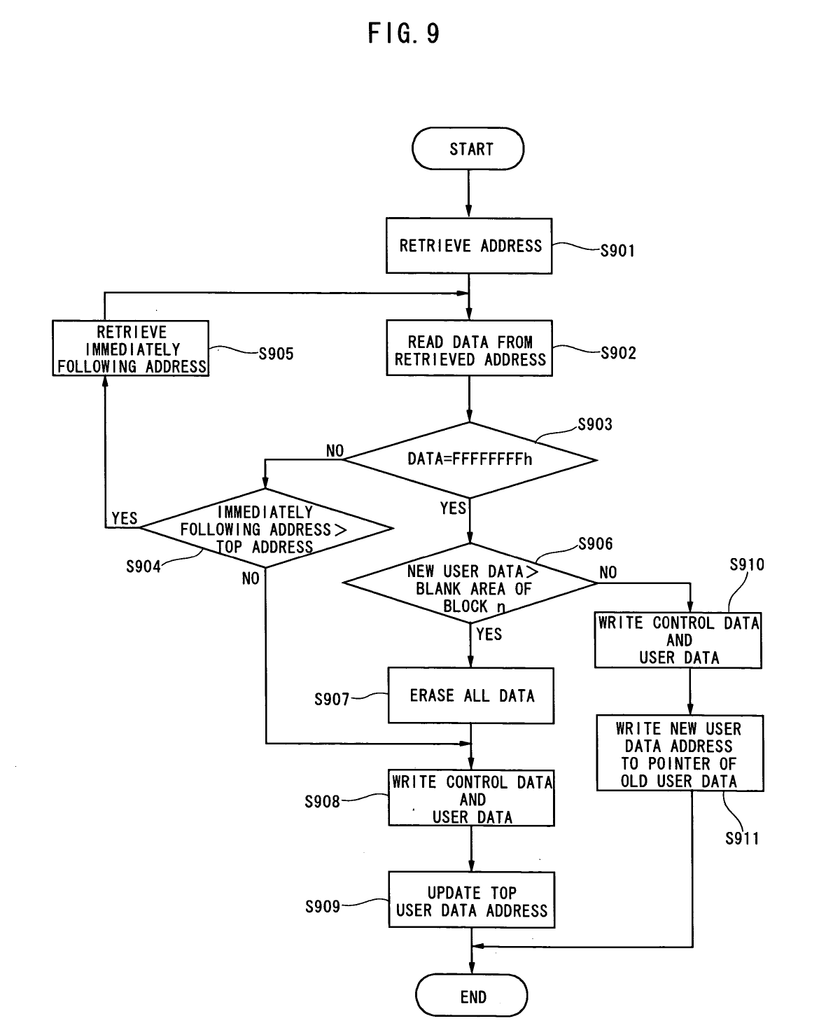

FIG. 9 is a flowchart showing the operation of the CPU 2 to write new user data to the flash memory 1. First, the CPU 2 searches Block n for the top address (S901). Retrieving the top address of Block n, the CPU 2 reads data stored in the top address (S902). Then, the CPU 2 determines whether the read data is blank or not (S903).

If the CPU 2 determines that the top address is not blank, it then determines whether an address immediately following the top address exists or not (S904). Since the unit of data written to the memory in this embodiment is four bytes, the CPU 2 checks the presence of an address located four bytes after.

If the CPU 2 determines that the immediately following address exists, it retrieves this address (S905), and the process returns to Step S902. The CPU 2 repeats Steps S902 to S905 until it determines in Step S903 that the read data is blank.

If the CPU 2 determines in Step S903 that the read data is blank, it then determines whether the size of the new user data is larger than the capacity of the blank area of Block n (S906).

If the CPU 2 determines that the size of the new user data is larger than the capacity of the blank area of Block n, it erases all the data stored in Block n (S907). After erasing all the data, the CPU 2 writes control data to the top address and further writes the new user data to the next address (S908). Then, the CPU 2 updates the top user data address retained in the application (S909)

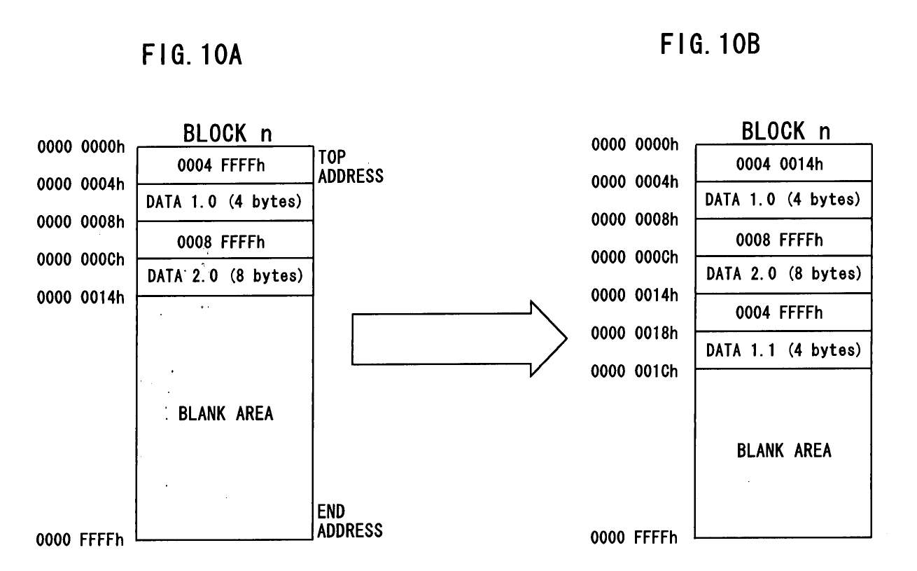

If, on the contrary, the CPU 2 determines in S906 that the size of the new user data is smaller than the capacity of the blank area of Block n, it writes control data to the address determined to be blank in Step S903 and further writes the new user data to the next address (S910). Then, the CPU 2 writes the address of the new user data to the pointer of the control data of old user data. (S911). Block n thereby becomes as shown in FIG. 10B.

If, on the other hand, the CPU 2 determines in Step S904 that the immediately following address does not exist, it determines that Block n is totally blank and the process proceeds to Step S908 to write control data to the top address and new user data to the next address.

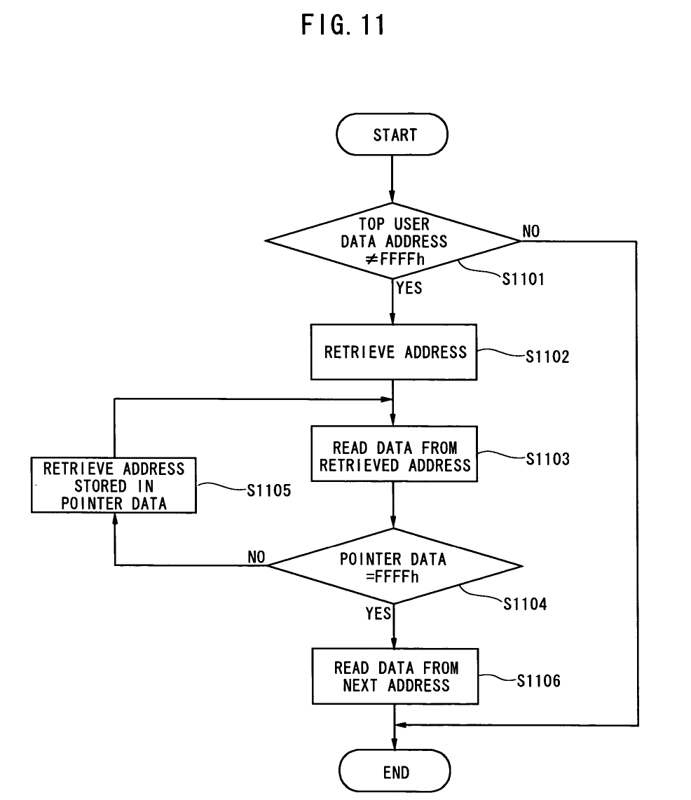

A method of reading user data written by the above method is explained below. FIG. 11 is a flowchart showing the operation of the CPU 2 to read user data from the flash memory 1 according to the third embodiment.

First, the CPU 2 determines whether a currently running application retains a top user data address or not (S1101). If the CPU 2 determines that the application does not retain a top address, it ends the process since the user data of the application is not stored in Block n.

If, on the other hand, the CPU 2 determines that the application retains a top address, it searches Block n for the top address retained in the application (1102). Retrieving the top address, the CPU 2 reads pointer data stored in the top address (S1103). Then, the CPU 2 determines whether the read pointer data is blank or not (S1104).

If the CPU 2 determines that the pointer data of the top address is not blank, it retrieves the address stored in the pointer data (S1105) and the process returns to Step S1103. The CPU 2 then repeats Steps S1103 to S1105 until it determines in S1104 that the read pointer data is blank.

If the CPU 2 determines in S1104 that the read pointer data is blank, it reads data from the immediately following address, which is the address located four bytes after (S1106).

Though the CPU 2 writes control data and user data sequentially from the top address of Block n, it may write control data and user data sequentially from the end address of Block n.

As described above, the third embodiment uses control data consisting of user data size and pointer data, thereby storing user data of a plurality of kinds of applications

Embodiment 4

A fourth embodiment of the present invention is explained hereinafter. The third embodiment allows storing data of a plurality of kinds of applications by storing user data and control data consisting of user data size and pointer. However, since the third embodiment searches for the address of the latest user data that is written last by following pointers sequentially from the top user data of each application based on the top user data address retained in each application, the read operation can take time. Thus, the fourth embodiment stores, as control data, an address where the latest user data of each application is written, in an area different from an EEPROM area of flash memory. This system allows the CPU 2 to retrieve the latest user data more quickly.

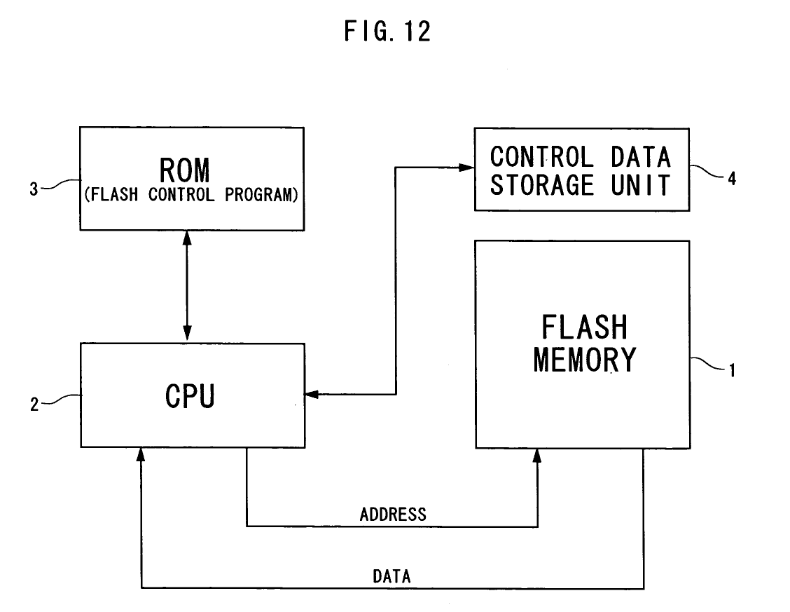

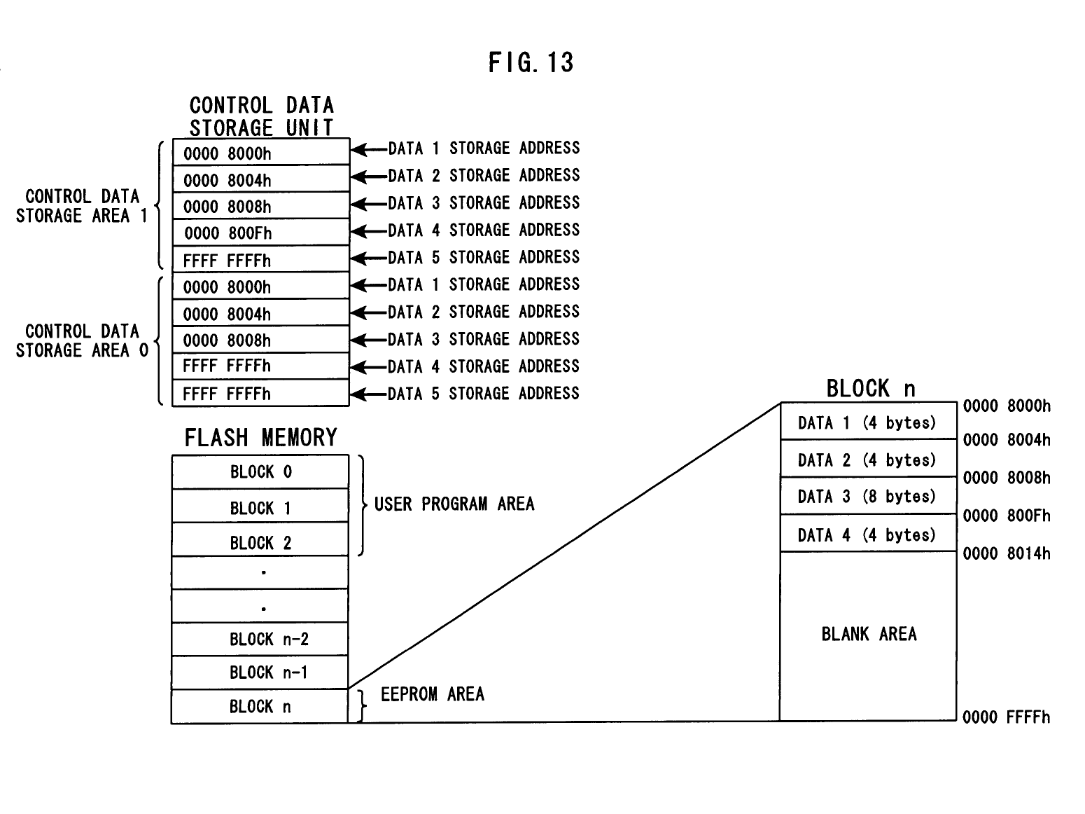

FIG. 12 is a block diagram of the fourth embodiment. FIG. 13 is a diagram showing flash memory and a control data storage unit according to the fourth embodiment.

Flash memory 1 in FIG. 12 is divided into a plurality of memory areas from Block 0 to n, as shown in FIG. 13. A user program area and an EEPROM area are predefined in the Blocks 0 to n. The user program area stores various data. The EEPROM area is used as an alternative for EEPROM. The fourth embodiment also uses Block n as the EEPROM area.

A CPU 2 in FIG. 12 writes user data to Block n sequentially from the top address. The CPU 2 further writes an address of user data of a corresponding application to a control data storage area 1 of a control data storage unit, which is described later. Though the CPU 2 writes four bytes of data each time in this embodiment, the unit of data is not limited to four bytes.

When writing new user data to Block n, the CPU 2 searches Block n sequentially from the top address to find a blank address. Retrieving the blank address, the CPU 2 determines whether the size of the new user data is smaller than the capacity of the blank area of Block n.

If the CPU 2 determines that the size of the new user data is smaller than the capacity of the blank area of Block n, it writes the new user data to the address determined as a blank. The CPU 2 further updates control data stored in the control data storage area 1, which is described later, and swaps a control data storage area 0 and the control data storage area 1.

If, on the other hand, the CPU 2 determines that the size of the new user data is larger than the capacity of the blank area of Block n, it erases all the data stored in Block n.

When reading user data stored in Block n, the CPU 2 reads control data of a corresponding application stored in the control data storage area 0 and reads data of an address written in the control data.

ROM 3 in FIG. 12 stores a program for the CPU 2 to execute so as to control the flash memory 1.

A control data storage unit 4 in FIG. 12 retains, as control data, the address where the latest user data is stored for each application. Each application retains a location where the address of the latest user data of the application stored in the control data storage unit 4.

The control data storage unit 4 is divided into the control data storage area 0 and the control data storage area 1 as shown in FIG. 13. Areas for storing control data of the latest user data for each application are predefined in the control data storage areas 0 and 1. The control data storage area 0 always retains new control data, and the control data storage area 1 retains control data before update.

A method of writing user data according to the fourth embodiment is explained below.

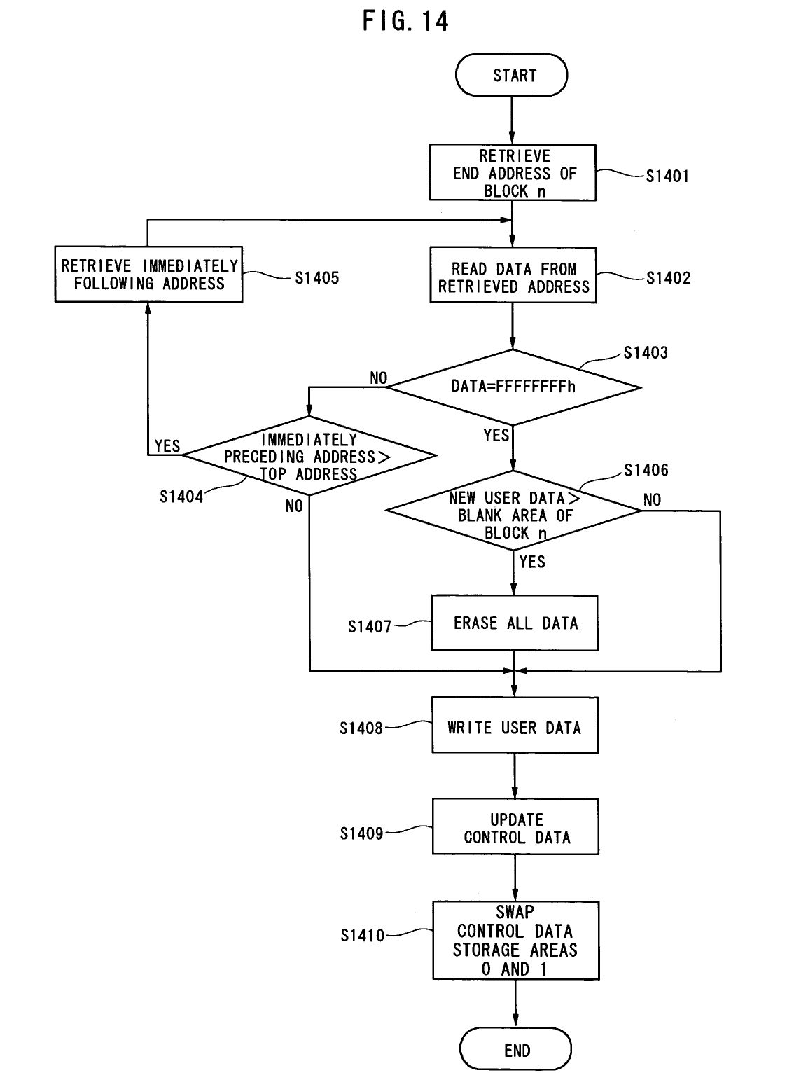

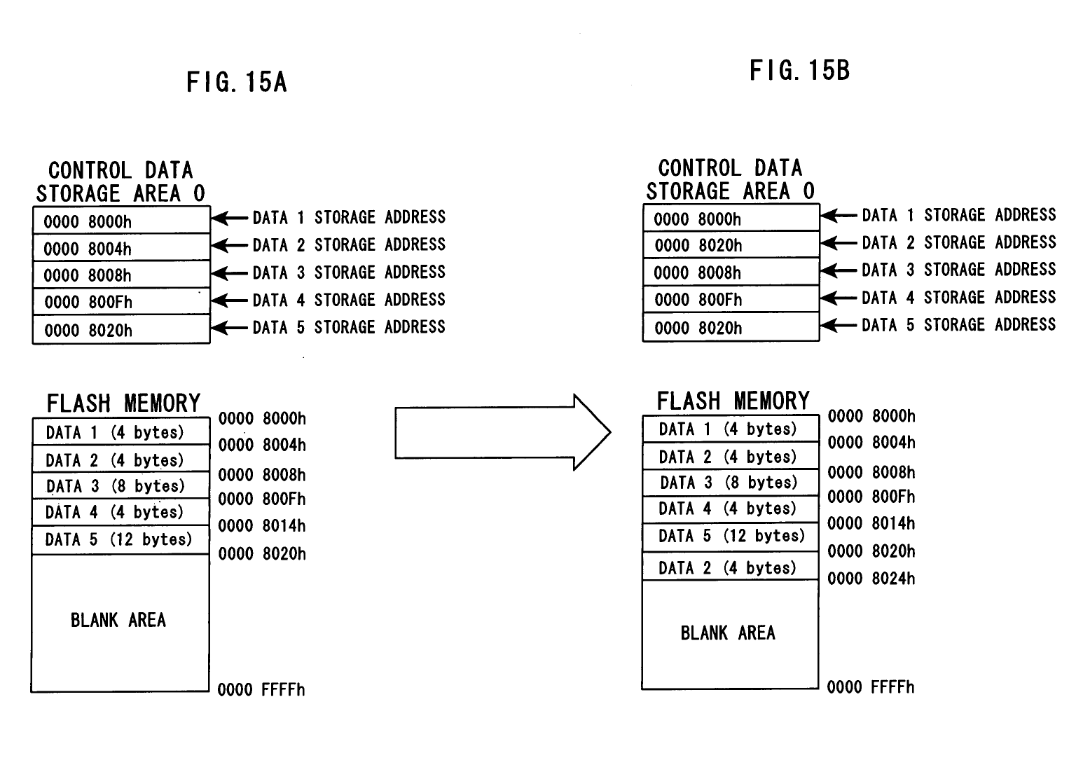

FIG. 14 is a flowchart showing the operation of the CPU 2 to write new user data. FIGS. 15A and 15B show the transition of Block n in the write operation.

In this embodiment, user data of five kinds of applications are stored in Block n, and control data of each application is stored in Data 1 storage address to Data 5 storage address of the control data storage areas 0 and 1, as shown in FIG. 15A, for example. In the example described below, the user data of a currently running application is “Date 2”, and a case of updating “Data 2” is explained.

First, the CPU 2 searches Block n for the end address (S1401). Retrieving the end address, the CPU 2 reads data stored in the end address (S1402). Then, the CPU 2 determines whether the read data is blank or not (S1403).

If the CPU 2 determines the end address to be blank, it then determines whether an address immediately preceding the end address exists or not (S1404). Since the unit of data written to the memory in this embodiment is four bytes, the CPU 2 checks the presence of an address located four bytes before.

If the CPU 2 determines that the immediately preceding address exists, it retrieves this address (S1405), and the process returns to Step S1402. The CPU 2 then repeats Steps S1402 to S1405 until it determines in S1403 that the read data is not blank.

If the CPU 2 determines in S1403 that the read data is not blank, it then determines whether the size of the new user data is larger than the capacity of the blank area of Block n (S1406).

If the CPU 2 determines that the size of the new user data is larger than the capacity of the blank area of Block n, it erases all the data stored in Block n (S1407). After that, the CPU 2 writes the new user data to the top address (S1408). Then, the CPU 2 writes control data of a currently running application to the control data storage area 1 (S1409). After updating the control data in the control data storage area 1, the CPU 2 swaps the control data stored in the control data storage area 1 and the control data stored in the control data storage area 0 (S1410).

If, on the contrary, the CPU 2 determines that the size of the new user data is smaller than the capacity of the blank area of Block n, the operation of the CPU 2 proceeds to Step S1408 to write the new user data to the address next to the address determined to be non-blank in Step S1403 (S1408). Then, the CPU 2 updates the control data of user data “Data 2” stored in the control data storage area 1 (S1409). After updating the control data, the CPU 2 swaps the control data stored in the control data storage area 1 and the control data stored in the control data storage area 0 (S1410).

If the CPU 2 determines in Step S1404 that the immediately preceding address does not exist, it determines that Block n is totally blank, and the process proceeds to Step S1408 to write the new user data to the top address (S1408). Then, the CPU 2 updates the control data of the user data “Data 2” stored in the control data storage area 1 (S1409). After updating the control data, the CPU 2 swaps the control data stored in the control data storage area 1 and the control data stored in the control data storage area 0 (S1410).

A method of reading the user data written by the above method is explained below.

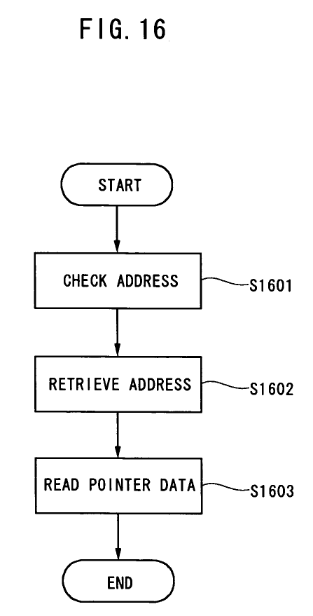

FIG. 16 is a flowchart showing the operation of the CPU 2 to read user data according to the fourth embodiment.

First, the CPU 2 checks the control data storage area 0 for the address of the top user data of a currently running application (S1601). If the control data storage area 0 does not have the address where its user data is stored, the CPU 2 ends the process since the user data of the application is not stored in Block n.

If, on the other hand, the CPU 2 determines that the control data storage area 0 retains the top address, it searches Block n for the address stored in the control data storage area 0 (S1602). Retrieving the address, the CPU 2 reads pointer data stored in the retrieved address (S1603).

Though the CPU 2 writes user data sequentially from the top address of Block n in the above embodiment, it may write user data sequentially from the end address of Block n. Further, though the above embodiment has a single control data storage unit and updates control data of an application each time new user data is written, it may have a plurality of control data storage units, each for each application, and write control data to the control data storage unit sequentially from top or end each time new user data is written. In this case, the CPU 2 searches the control data storage unit sequentially from top or end for control data written last, and reads user data based on the retrieved control data.

A method of swapping the control data storage areas 0 and 1 is explained below.

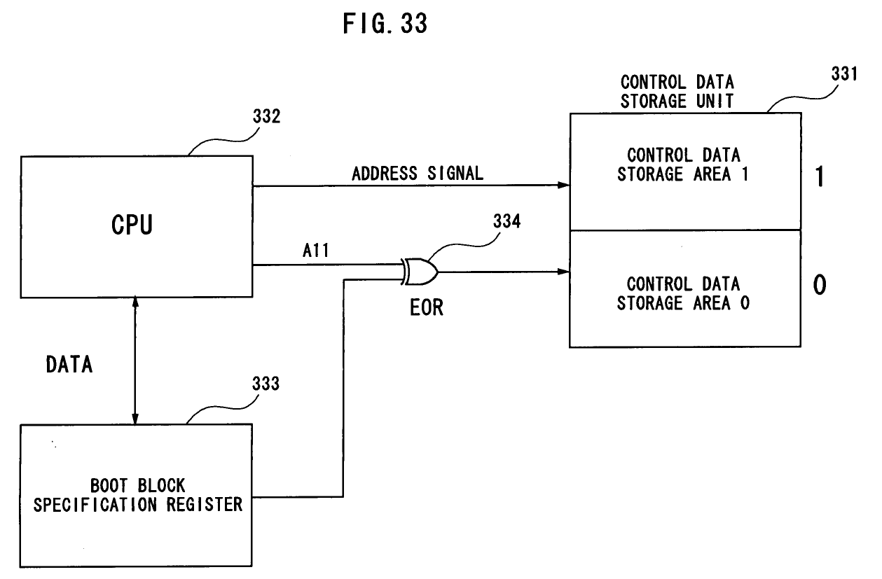

FIG. 33 is a block diagram to explain the swap method.

A control data storage unit 331 in FIG. 33 is the same as the control data storage unit 4 shown in FIG. 12. The control data storage unit 331 includes Block 0 with the block number 0 and Block 1 with the block number 1. Block 0 stores a control data storage area 0, and Block 1 stores a control data storage area 1.

A CPU 332 in FIG. 33 is the same as the CPU 2 shown in FIG. 12. The CPU 332 always specifies the block number 1 when updating control data of the control data storage area 1 and specifies the block number 0 when updating control data of the control data storage area 0. When swapping the control data storage areas 0 and 1, the CPU 332 checks the value of a boot block register, which is described later, and writes 0 or 1 to a boot block specification register.

A boot block specification register 333 in FIG. 33 is written with 0 or 1 by the CPU 332 when swapping the control data storage areas 0 and 1.

An exclusive OR (EXOR) circuit 334 inverts an address signal from the CPU 332 based on the value stored in the boot block specification register 333. If the boot block specification register 333 stores 0, the EXOR circuits 334 does not invert an address signal; if the register 333 stores 1, it inverts an address signal.

A method of swapping the control data storage areas 0 and 1 is explained below. In this example, the boot block specification register 333 currently stores 0 and Block 1 stores the control data storage area 1.

When updating control data in Step S1409, the CPU 332 first specifies the block number 1 of the control data storage unit 331. Since the boot block specification register 333 is written with 0, the CPU 332 determines that the current control data storage area 1 is stored in Block 1 and thus updates the control data storage area 1 in Block 1. After that, the CPU 332 checks the value of the boot block specification register 333. Since the value is 0, the CPU 332 changes the value of the boot block specification register 333 to 1.

In the next update of control data, the CPU 332 again specifies the block number 1 of the control data storage unit. However, since the boot block specification register 333 is written with 1, the CPU 332 determines that the current control data storage area 1 is stored in Block 0, and the EXOR circuit 334 inverts the address signal. The CPU 332 thereby updates the control data storage area 1 stored in Block 0. After that, the CPU 332 checks the value of the boot block specification register 333. Since the value is 1, the CPU 332 changes the value of the boot block specification register 333 to 0.

A method of reading data swapped by the above method is explained below.

When the CPU 2 checks the control data storage area 0 for the address where the user data of a currently running application is stored in S1601, it specifies the block number 0 of the control data storage unit 331. If the boot block specification register 333 is written with 1, the CPU 332 determines that the current control data storage area 0 is stored in Block 1, and the EXOR circuit 334 inverts the address signal so that the CPU 332 specifies Block 1. If, on the other hand, the boot block specification register 333 is written with 0, the CPU 332 determines that the current control data storage area 0 is stored in Block 0, and the EXOR circuit 334 does not invert the address signal so that the CPU 332 specifies Block 0.

Embodiment 5

A fifth embodiment of the present invention is explained hereinafter.

Though the embodiments described above use a single block of flash memory as an EEPROM area, the fifth embodiment uses a plurality of blocks as an EEPROM area. In this embodiment, like the third and fourth embodiments, an address of user data of each application in Block n is stored in an area different from an area to store user data. This embodiment is explained using the writing method of the fourth embodiment.

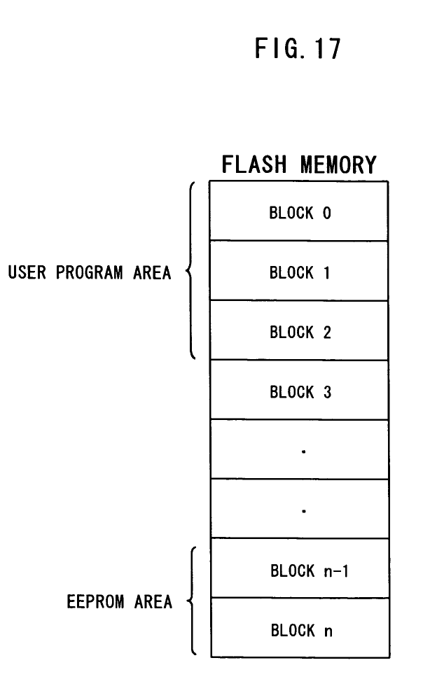

FIG. 17 is a block diagram of the flash memory 1 according to the fifth embodiment.

The flash memory 1 is divided into a plurality of memory areas from Block 0 to n, as shown in FIG. 17. A user program area and an EEPROM area are predefined in the Blocks 0 to n. The user program area stores various data. The EEPROM area is used as an alternative for EEPROM. The fifth embodiment uses Block n and Block n−1 as the EEPROM area.

When writing new user data of a currently running application to the flash memory 1, the CPU 2 erases all the user data stored in Block n−1. Then, the CPU 2 reads user data of applications, which are not currently running, from Block n and writes the data to Block n−1, thereby swapping Block n and Block n−1.

When reading user data stored in Block n, the CPU 2 reads the user data based on an address where the latest user data of each application is written, which is retained in each application.

The data writing method according to this embodiment is explained below.

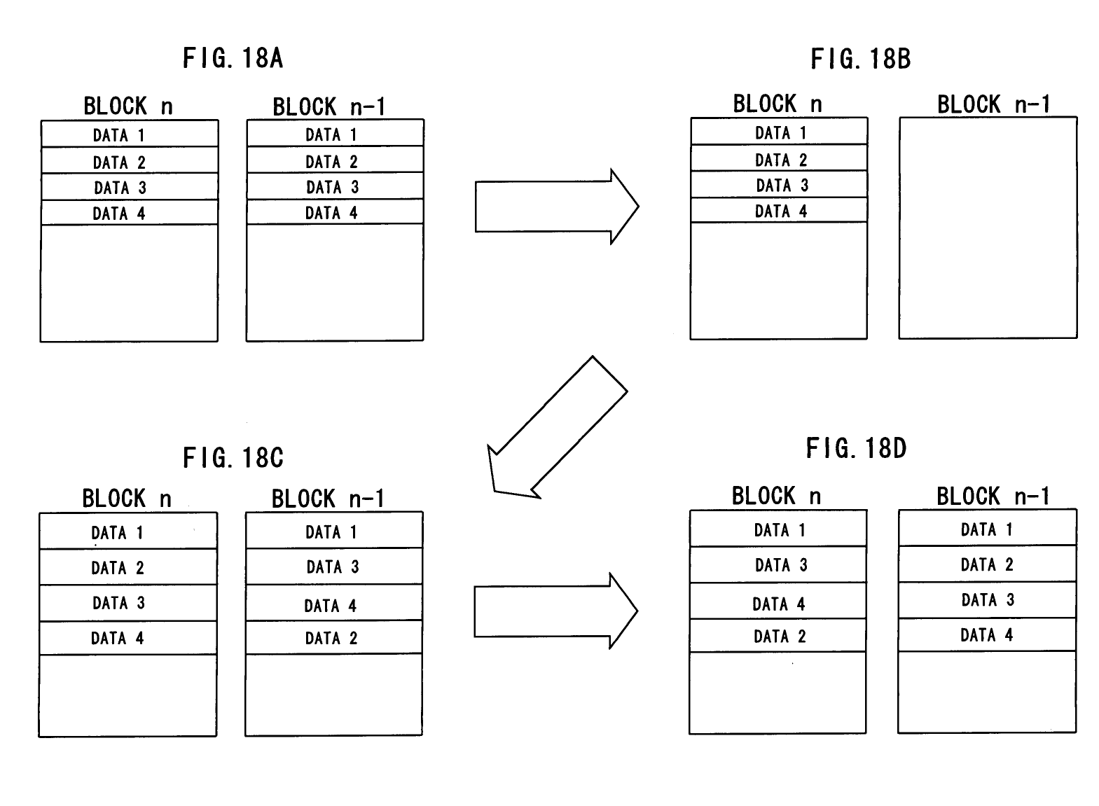

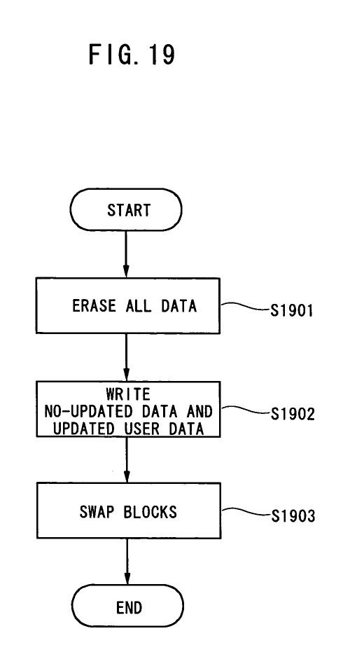

FIGS. 18A to 18D show the transition of Block n and Block n−1. FIG. 19 is a flowchart showing data write operation. FIGS. 18A to 18D show the case where initially user data of four kinds of applications are stored in Block n. In the example described below, the user data of a currently running application is “Date 2”, and a case of updating “Data 2” is explained.

When writing new user data “Data 2”, the CPU 2 first erases all the user data stored in Block n−1 (S1901). Block n and Block n−1 thereby become as shown in FIG. 18B.

Then, the CPU 2 reads user data that is not updated from Block n, and writes the no-updated data together with updated data to Block n−1 (S1902). Block n and Block n−1 thereby become as shown in FIG. 18C.

After that, the CPU 2 swaps Block n−1 and Block n (S1903). Block n and Block n−1 thereby become as shown in FIG. 18D.

A method of reading the user data written by the above method is explained below.

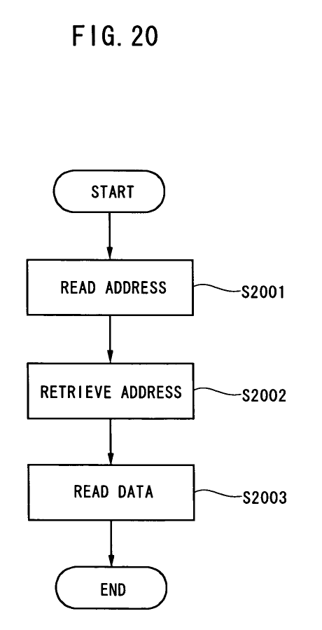

FIG. 20 is a flowchart showing data read operation according to the fifth embodiment.

First, the CPU 2 reads an address where user data of a currently running application is stored, which is retained in the application (S2001). Then, the CPU 2 retrieves the address where the user data of the application is stored from Block n (S2002). After that, the CPU 2 reads data from the retrieved address (S2003).

This system allows retaining a block storing the latest user data and a block storing immediately preceding user data.

A swap method of the present invention is the same as the swap method explained in the fourth embodiment.

This embodiment, like the third and fourth embodiments, describes the case where an address of user data of each application written to Block n is stored in an area different from an area to store user data. The first and second embodiments may also use a plurality of blocks as an EEPROM area. In this case, the CPU 2 writes user data to Block n and, when Block n becomes full, it swaps Block n and Block n−1. A swap method of this case is also the same as the swap method explained in the fourth embodiment.

Embodiment 6

A sixth embodiment of the present invention is explained hereinafter.

The present embodiment conducts internal verification after writing user data to the EEPROM area of flash memory by the method described in the above embodiments. This embodiment is explained using the writing method of the fourth embodiment.

The structure of the sixth embodiment is the same as that of the fourth embodiment shown in FIG. 12. The same elements are denoted by the same reference symbols and redundant description is omitted.

The CPU 2 verifies all the data stored in Block n upon completion of new user data writing.

A method of writing user data according to the sixth embodiment is explained below.

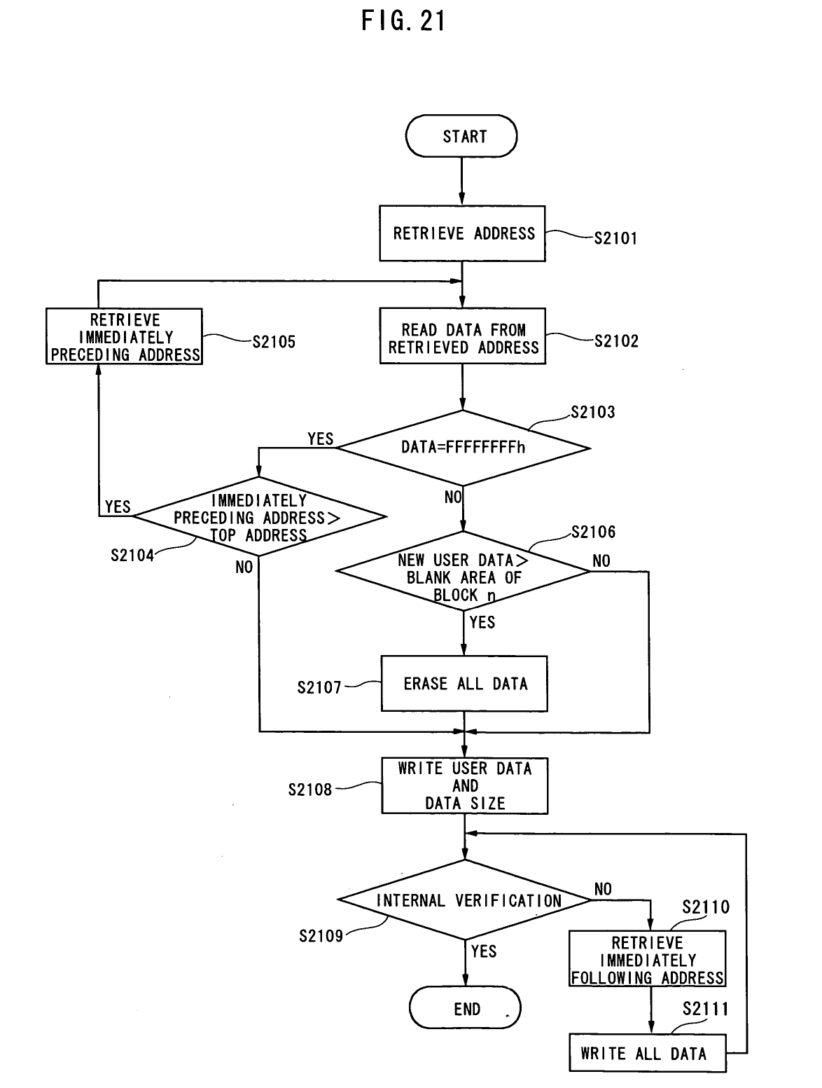

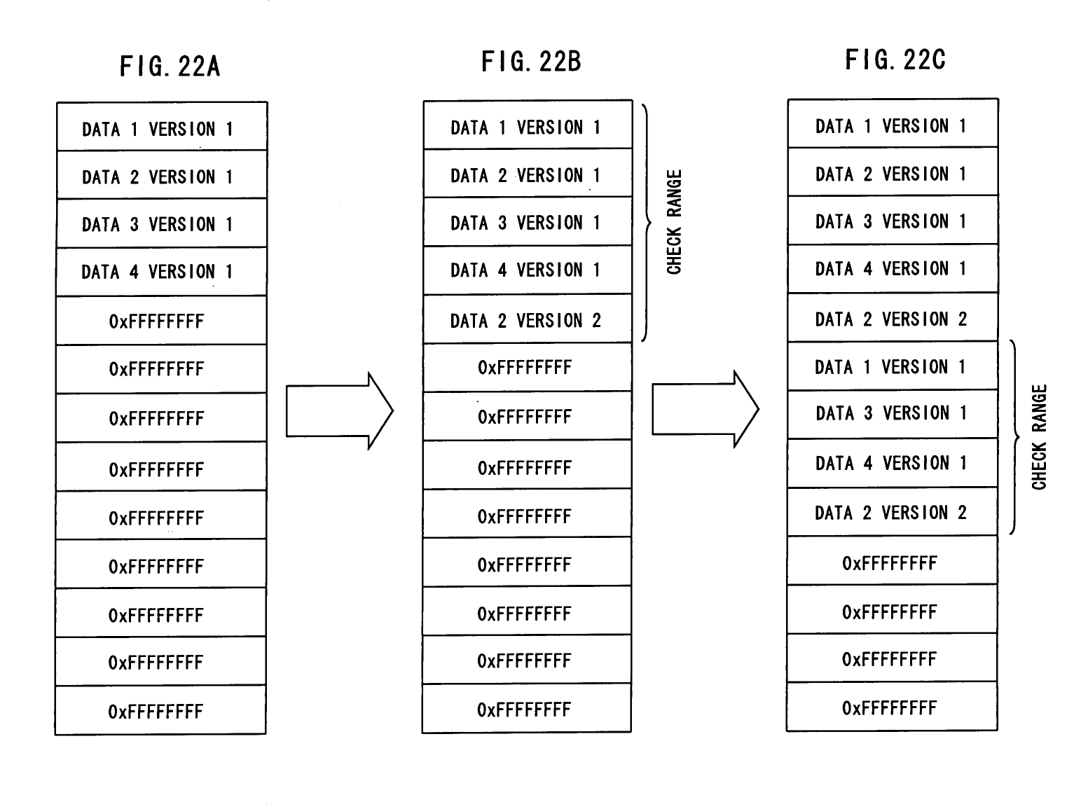

FIG. 21 is a flowchart showing the operation of the CPU 2 to write user data. FIGS. 22A to 22C show the transition of Block n in the write operation. FIGS. 22A to 22C show the case where user data of four kinds of applications, “Data 1” to “Data 4”, are stored initially. In the example described below, the user data of a currently running application is “Date 2” and “Data 2” is updated.

First, the CPU 2 searches Block n for the end address (S2101). Retrieving the end address, the CPU 2 reads the data stored in the end address (S2102). Then, the CPU 2 determines whether the read data is blank or not (S2103).

If the CPU 2 determines the end address to be blank, it then determines whether an address immediately preceding the end address exists or not (S2104). Since the unit of data written to the memory in this embodiment is four bytes, the CPU 2 checks the presence of an address located four bytes before.

If the CPU 2 determines that the immediately preceding address exists, it retrieves this address (S2105), and the process returns to Step S2102. The CPU 2 then repeats Steps S2102 to S2105 until it determines in S2103 that the read data is not blank.

If the CPU 2 determines in S2103 that the read data is not blank, it then determines whether the size of the new user data is larger than the capacity of the blank area of Block n (S2106).

If the CPU 2 determines that the size of the new user data is larger than the capacity of the blank area of Block n, it erases all the data stored in Block n (S2107). After erasing all the data, the CPU 2 writes the new user data to the top address and updates control data (S2108).

If, on the contrary, the CPU 2 determines that the size of the new user data is smaller than the capacity of the blank area of Block n, the operation of the CPU 2 proceeds to Step S2108 to write the new user data to the address next to the address determined to be non-blank and update the control data (S2108). Block n thereby becomes as shown in FIG. 22B.

If the CPU 2 determines in Step S2104 that the immediately preceding address does not exist, it determines that Block n is totally blank, and the process proceeds to Step S2108.

After writing the new user data and data size, the CPU 2 verifies all the data stored in Block n (S2109). If the verification fails, the CPU 2 retrieves the next address (S2110) and writes the latest data of all the data (S2111). Block n thereby becomes as shown in FIG. 22C.

The CPU 2 then repeats Steps S2109 to S2111 until the verification completes normally in S2109.

The write operation ends upon normal completion of the verification.

A method of reading the user data written by the above method is explained below.

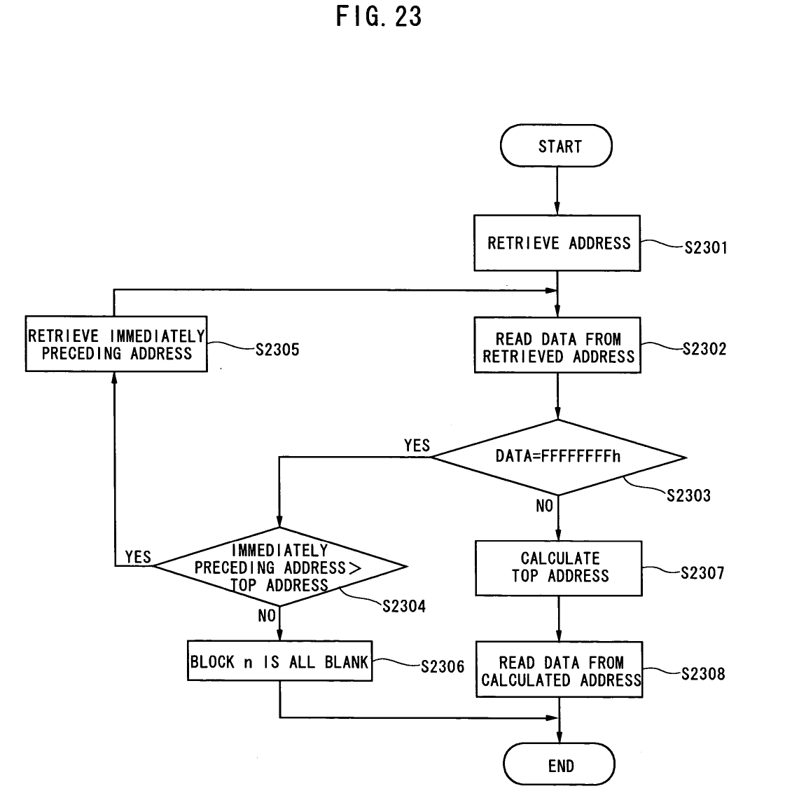

FIG. 23 is a flowchart showing the operation of the CPU 2 to read user data according to the sixth embodiment.

The CPU 2 first retrieves the end address of Block n (S2301). The CPU 2 then reads data stored in the retrieved address (S2302). After that, the CPU 2 determines whether the read data is blank or not (S2303).

If the CPU 2 determines that the read data is blank, it then determines whether an immediately preceding address exists or not (S2304).

If the CPU 2 determines that the immediately preceding address exists, it retrieves this address (S2305), and the process returns to Step S2302. If, on the contrary, the CPU 2 determines that the immediately preceding address does not exist, it determines that Block n is totally blank and ends the read process (S2306).

If, on the other hand, the CPU 2 determines in Step S2303 that the read data is not blank, it calculates a top address that stores the latest user data based on the user data size stored in this address (S2307). The CPU 2 then reads the user data stored in the calculated address (S408).

Though this embodiment is explained using the writing method described in the fourth embodiment, any of the methods described in the above embodiments may be used.

Embodiment 7

In the sixth embodiment, the CPU 2 conducts internal verification after user data writing and, if the internal verification fails, it retrieves the next blank area and writes data to the retrieved area. The failure of the internal verification, however, means that user data is not properly written. The data that is not properly written can be the same as a different delimiter in the same block. If the data is the same as a different delimiter in the same block, the CPU 2 can read data which is not right user data. To prevent this, a seventh embodiment overwrites error data where the internal verification fails with zero data (00h) so as not to read the error data. This embodiment is explained using the writing method of the first embodiment.

The structure of the seventh embodiment is the same as that of the sixth embodiment, and redundant explanation is omitted.

A method of writing user data according to this embodiment is explained below.

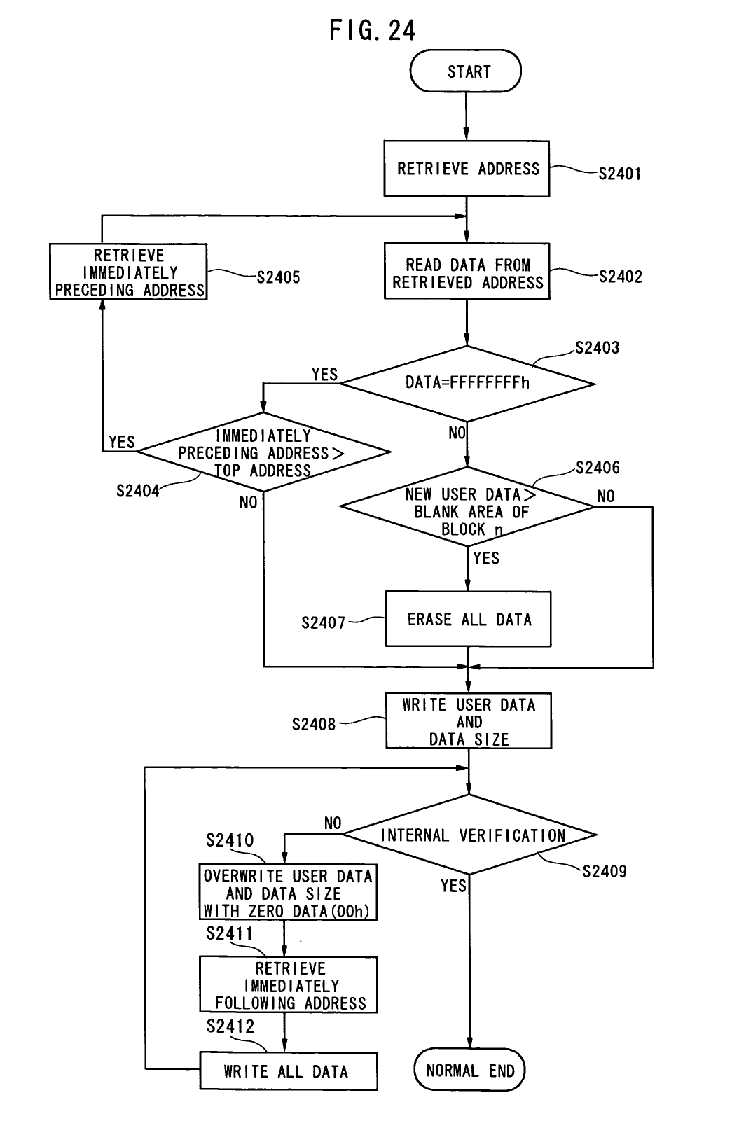

FIG. 24 is a flowchart showing the operation of the CPU 2 to write user data.

First, the CPU 2 searches Block n for the end address (S2401). Retrieving the end address, the CPU 2 reads data stored in the end address (S2402). Then, the CPU 2 determines whether the read data is blank or not (S2403).

If the CPU 2 determines the end address to be blank, it then determines whether an address immediately preceding the end address exists or not (S2404). Since the unit of data written to the memory in this embodiment is four bytes, the CPU 2 checks the presence of an address located four bytes before.

If the CPU 2 determines that the immediately preceding address exists, it retrieves this address (S2405), and the process returns to Step S2402. The CPU 2 then repeats Steps S2402 to S2405 until it determines in S2403 that the read data is not blank.

If the CPU 2 determines in S2403 that the read data is not blank, it then determines whether the size of the new user data is larger than the capacity of the blank area of Block n (S2406).

If the CPU 2 determines that the size of the new user data is larger than the capacity of the blank area of Block n, it erases all the data stored in Block n (S2407). After erasing all the data, the CPU 2 writes the new user data to the top address and updates control data (S2408).

If, on the contrary, the CPU 2 determines that the size of the new user data is smaller than the capacity of the blank area of Block n, the operation of the CPU 2 proceeds to Step S2408 to write the new user data to the address next to the address determined to be non-blank and update the control data (S2408).

If the CPU 2 determines in Step S2404 that the immediately preceding address does not exist, it determines that Block n is totally blank, and the process proceeds to Step S2408.

After writing the new user data and data size, the CPU 2 verifies all the data stored in Block n (S2409). If the verification fails, the CPU 2 overwrites the written user data and data size with zero data (S2410). After that, the CPU retrieves the next address (S2411) and writes the latest data of all the data (S2412).

The CPU 2 then repeats Steps S2409 to S2412 until the verification completes normally in S2409.

The write operation ends upon normal completion of the verification.

Though this embodiment is explained using the writing method of the first embodiment, any of the methods described in the above embodiments may be used. A method of reading user data of the seventh embodiment is the same as that of the first embodiment.

Embodiment 8

In the process of writing user data to flash memory, if using a single block as an EEPROM area, the above embodiments sequentially write new user data to the block. When the block has no more blank area, it temporarily saves the new user data to RAM and, after erasing the user data in the block, it writes the new user data back to the flash memory. However, if power is turned off by accident during this process, the new data stored in volatile memory such as RAM is lost. Thus, the eighth embodiment uses two blocks as an EEPROM area of flash memory and, when a first block becomes full, it copies written data in the first block to a second block and erases all the data in the first block.

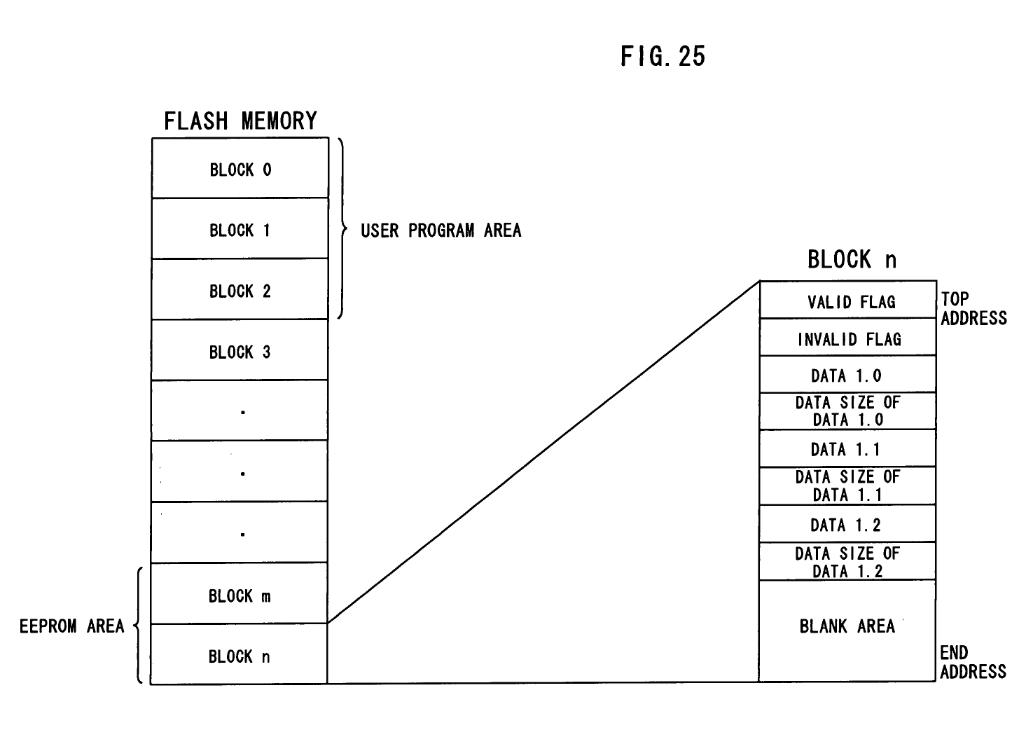

FIG. 25 is a block diagram of flash memory according to the eighth embodiment. As shown in FIG. 25, this embodiment uses Block m and Block n as the EEPROM area. Blocks m and n are each divided into a valid flag area where a valid flag is written, an invalid flag area where an invalid flag is written, and a user data area where user data is written.

A method of writing user data according to the eighth embodiment is explained below.

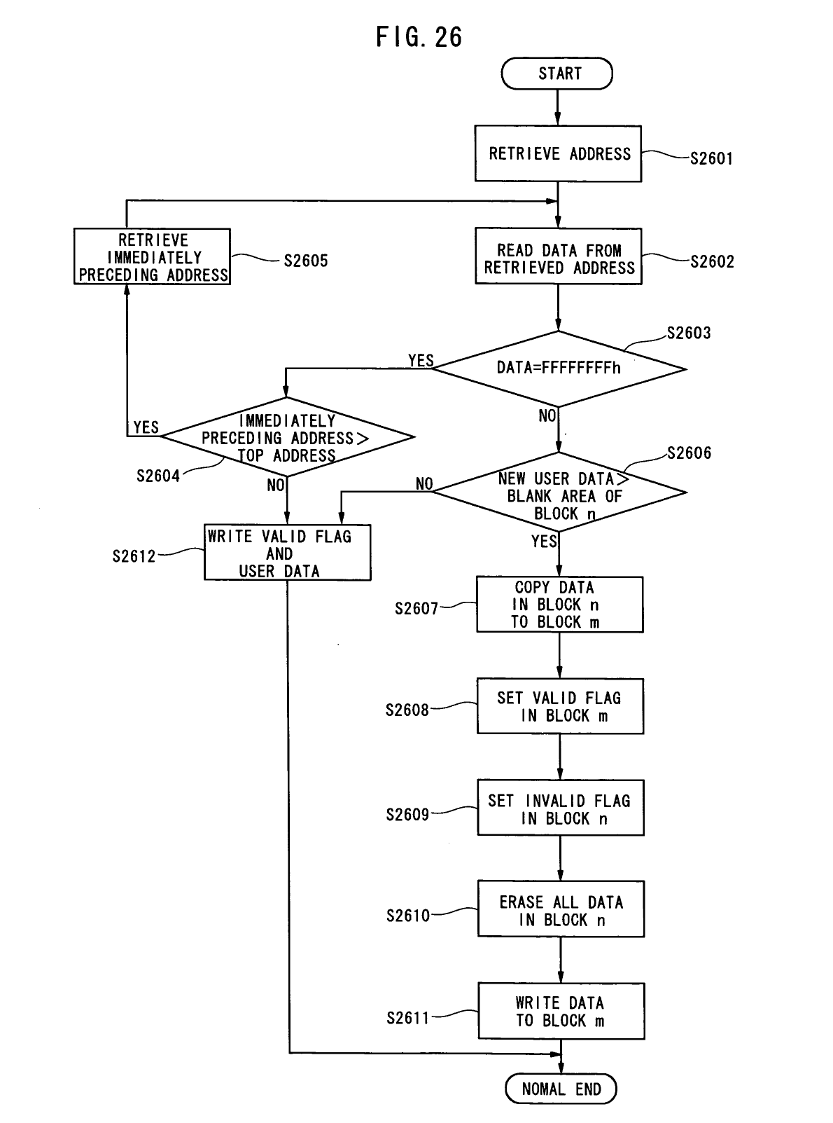

FIG. 26 is a flowchart showing the operation of the CPU 2 to write user data.

First, the CPU 2 searches Block n for the end address (S2601). Retrieving the end address, the CPU 2 reads data stored in the end address (S2602). Then, the CPU 2 determines whether the read data is blank or not (S2603).

If the CPU 2 determines the end address to be blank, it then determines whether an address immediately preceding the address determined as a blank exists or not (S2604). Since the unit of data written to the memory in this embodiment is four bytes, the CPU 2 checks the presence of an address located four bytes before.

If the CPU 2 determines that the immediately preceding address exists, it retrieves this address (S2605), and the process returns to Step S2602. The CPU 2 then repeats Steps S2602 to S2605 until it determines in S2403 that the read data is not blank.

If the CPU 2 determines in S2603 that the read data is not blank, it then determines whether the size of the new user data is larger than the capacity of the blank area of Block n (S2606).

If the CPU 2 determines that the size of the new user data is larger than the capacity of the blank area of Block n, it copies the latest user data stored in Block n to Block m (S2607). After that, the CPU 2 sets a flag in the valid flag area of Block m (S2608) Further, the CPU 2 sets a flag in the invalid flag area of Block n (S2609) and erases all the data in Block n (S2610). The CPU 2 then writes user data to Block m where the flag is currently set in the valid flag area (S2611).

If, on the other hand, the CPU 2 determines in Step S2606 that the size of the new user data is smaller than the capacity of the blank area of Block n, the CPU 2 sets a flag in the valid flag area and writes the new user data to the address next to the address determined to be non-blank and further writes the size of the written user data to the next address (S2612).

If the CPU 2 determines in Step S2604 that the immediately preceding address does not exist, it determines that Block n is totally blank, and the process proceeds to Step S2612.

Though this embodiment is explained using the writing method of the first embodiment, any of the methods described in the above embodiments may be used. A method of reading user data of the eighth embodiment is the same as that of the first embodiment.

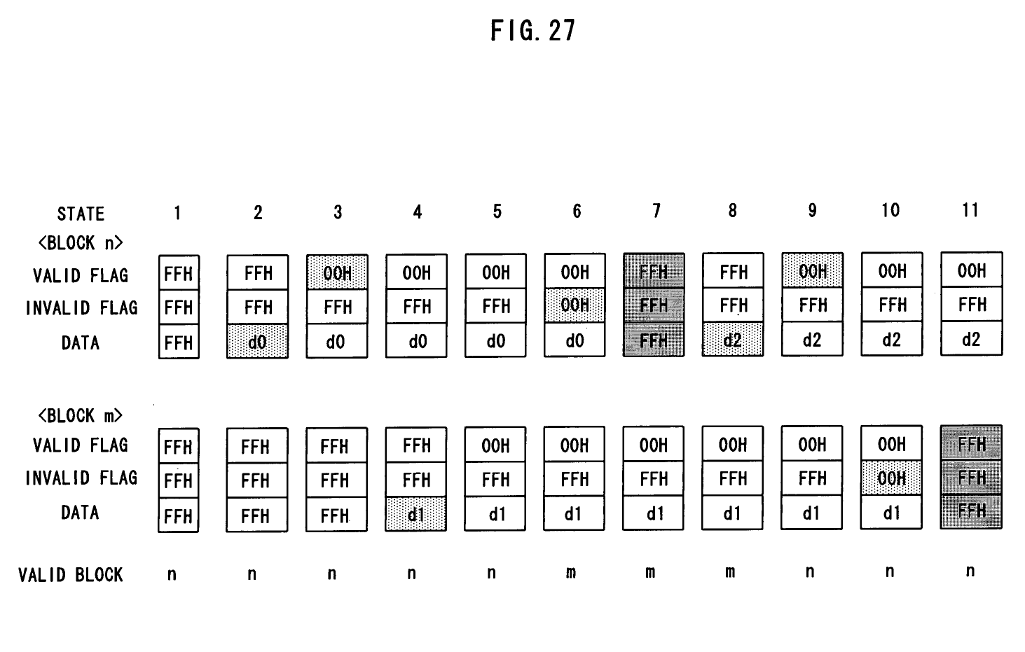

A method of setting a flag in Block m and Block n is explained below. FIG. 27 shows the transition of Block m and Block n according to the eighth embodiment.

Initially, Blocks n and m store no data as shown in State 1 in FIG. 27. Then, user data is written to Block n (State 2). To validate Block n storing the user data, a valid flag is set in Block n by writing 00h to the valid flag area of Block n (State 3). User data is then sequentially written to Block n. When Block n becomes full with no more blank area, the latest user data in Block n is copied to Block m (State 4). The copied data is d1. After that, to validate Block m, a valid flag is set in Block m (State 5). The valid flag is thereby set in both Block n and m. It is predetermined that the valid block is Block n if both Block n and m have the valid flat set. Thus, the valid block in this state is Block n.

Then, an invalid flag is set in Block n, and Block m thereby becomes the only valid area (State 6). The data stored in Block n is erased (State 7). The valid block is now Block m, and user data is sequentially written to Block m. When Block m becomes full with no more blank area, the latest user data in Block m is copied to Block n (State 8).

To validate Block n, a valid flag is set in Block n (State 9). The valid flag is thereby set in both Blocks n and m. In such a case, the valid block is Block n as described above. An invalid flag is then set in Block m to make Block m the only valid area (State 10). After that, the data stored in Block m is erased (State 11).

As described above, this embodiment is configured to determine a block where a valid flag is set and an invalid flag is not set to be a valid block

Embodiment 9

A data processing unit that uses a part of flash memory as an alternative for EEPROM using any of the above methods is described hereinafter.

A ninth embodiment of the present invention is explained below.

Conventionally, in the case of using a part of flash memory as an alternative for EEPROM, the process of writing user data to all of EEPROM alternative area and then erasing all the user data in the EEPROM alternative area to write new user data causes CPU resource to be occupied, which can stop other processing.

To avoid this problem, the system according to the present embodiment includes a controller to exclusively perform the above process so as to rewrite data without occupying the CPU resource.

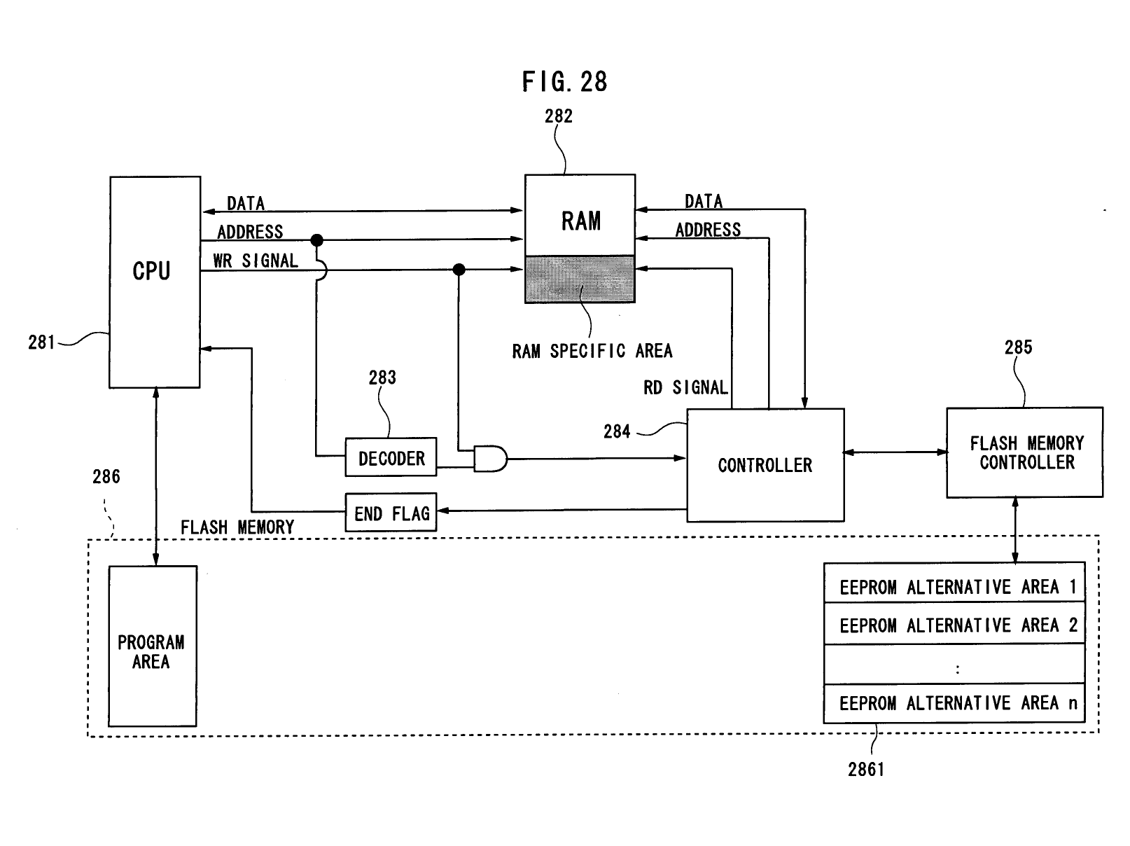

FIG. 28 is a block diagram showing the present embodiment of the invention.

A CPU 281 outputs data and activates a WR signal to write data.

RAM 282 is dual-port RAM. The RAM 282 stores data written by the CPU 281. The RAM 282 includes a specific area defined by a fixed address. The specific area may be defined by an address predetermined by a register and so on in a controller, which is described later.

A decoder 283 decodes a destination address when the CPU 281 activates the WR signal.

A controller 284 reads the address decoded by the decoder 283 when the CPU 281 activates the WR signal and, if the address is in the specific area of the RAM 282, it outputs the address and activates an RD signal to read data stored in the specific area of the RAM 282.

A flash memory controller 285 writes the user data read by the controller 284 to an EEPROM alternative area of flash memory, which is described later. A method of writing the user data to the EEPROM alternative area may be any method described in the first to sixth embodiments. The flash memory controller 285 further reads the data stored in the EEPROM area of the flash memory.

A flash memory 286 is divided into a program area for storing program and an EEPROM alternative area 2861 for storing data written to the specific area of the RAM 282.

A method of writing data in the above system is explained below.

When the CPU 281 activates the WR signal to the RAM 282, the decoder 283 decodes a destination address. If the destination address is in the specific area of the RAM 282, the controller 284 activates the RD signal to the RAM 282 and reads the data stored in the specific area of the RAM 282.

Then, the flash memory controller 285 writes the data read by the controller 284 to the EEPROM alternative area 2861 of the flash memory 286. After that, the flash memory controller 285 sends a status to the controller 284.

Receiving the status, the controller 284 sets an end flag, thereby notifying the CPU 281 that data writing to the EEPROM area 2861 ends.

This system allows rewriting data to the EEPROM alternative area 2861 of the flash memory 286 without occupying the resource of the CPU 281.

Embodiment 10

A tenth embodiment of the present invention is explained hereinafter.

Since the above system writes data to the EEPROM alternative area each time user data is written to the specific area of the RAM, it shortens the life of the flash memory. Thus, a system according to the present embodiment writes user data to the EEPROM area of the flash memory only when the CPU sets start trigger or upon interrupt from a peripheral macro.

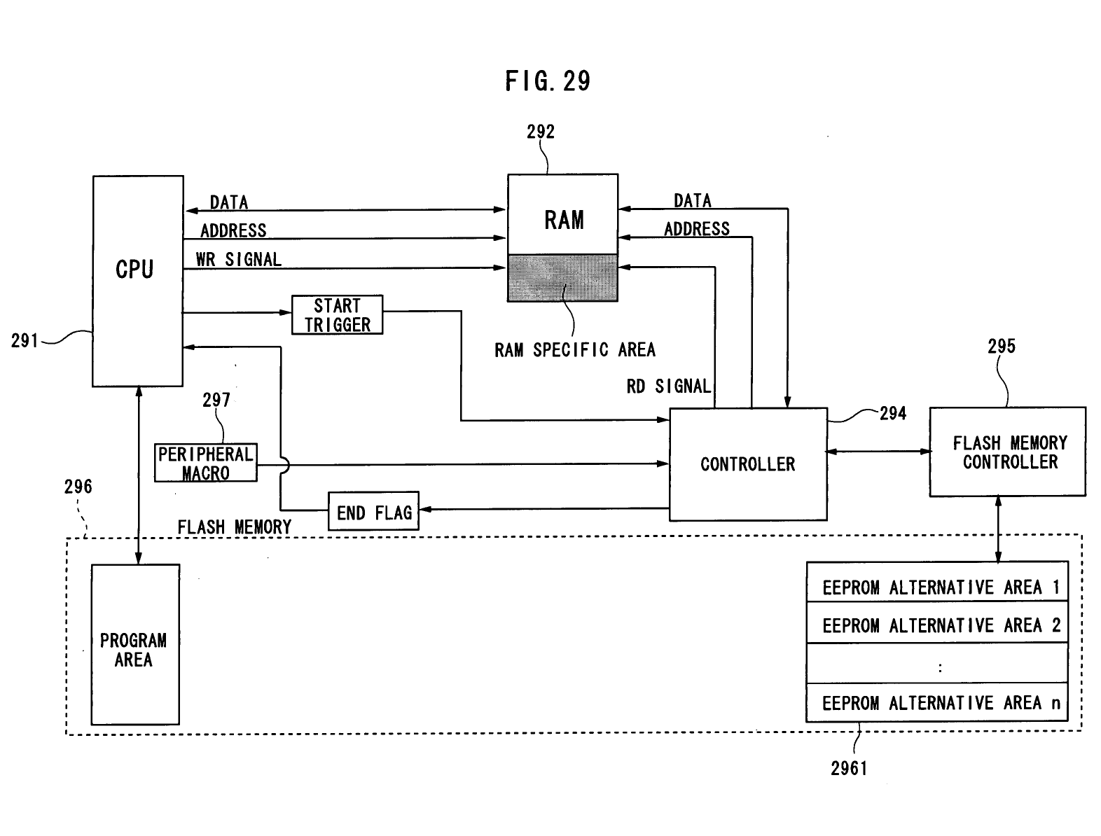

FIG. 29 is a block diagram of the tenth embodiment.

A CPU 291 outputs data and activates a WR signal when writing data. Further, the CPU 291 sets start trigger at a predetermined time such as at power-off.

RAM 292 is dual-port RAM. The RAM 292 stores data written by the CPU 291. The RAM 292 includes a specific area defined by a fixed address. The specific area may be defined by an address predetermined by a register and so on in a controller, which is described later.

A controller 294 outputs an address and activates an RD signal to read data stored in the specific area of the RAM 292 when the CPU 291 sets start trigger or when a peripheral macro sets interrupt trigger.

A flash memory controller 295 writes the user data read by the controller 294 to an EEPROM alternative area of flash memory. A method of writing the user data to the EEPROM alternative area may be any method described in the first to sixth embodiments. The flash memory controller 295 further reads the data stored in the EEPROM area of the flash memory.

A flash memory 296 is divided into a program area for storing program and an EEPROM alternative area 2961 for storing data written to the specific area of the RAM 292.

A peripheral macro 297 sets interrupt trigger at a predetermined time such as when a low voltage indicator (LVI) macro detects battery voltage drop.

A method of writing data in the above system is explained below.

First, the CPU 291 activates the WR signal to the RAM 292 and writes data to the specific area of the RAM 292. After that, when the CPU 291 sets start trigger or the peripheral macro 297 sets interrupt trigger, the controller 294 activates the RD signal to the RAM 292 and reads the data stored in the specific area of the RAM 292.

Then, the flash memory controller 295 writes the data read by the controller 294 to the EEPROM alternative area 2961 of the flash memory 296. After that, the flash memory controller 295 sends a status to the controller 294.

Receiving the status, the controller 294 sets an end flag, thereby notifying the CPU 291 that data writing to the EEPROM area 2961 ends.

Since the above system writes user data to the EEPROM area 2961 of the flash memory 296 only when it is necessary, such as when the CPU sets start trigger or upon interrupt from a peripheral macro, it is possible to extend the life of the flash memory.

Embodiment 11

An eleventh embodiment of the present invention is explained hereinafter.

This embodiment describes the case where the dual-port RAM of the ninth embodiment is replaced with single-port RAM.

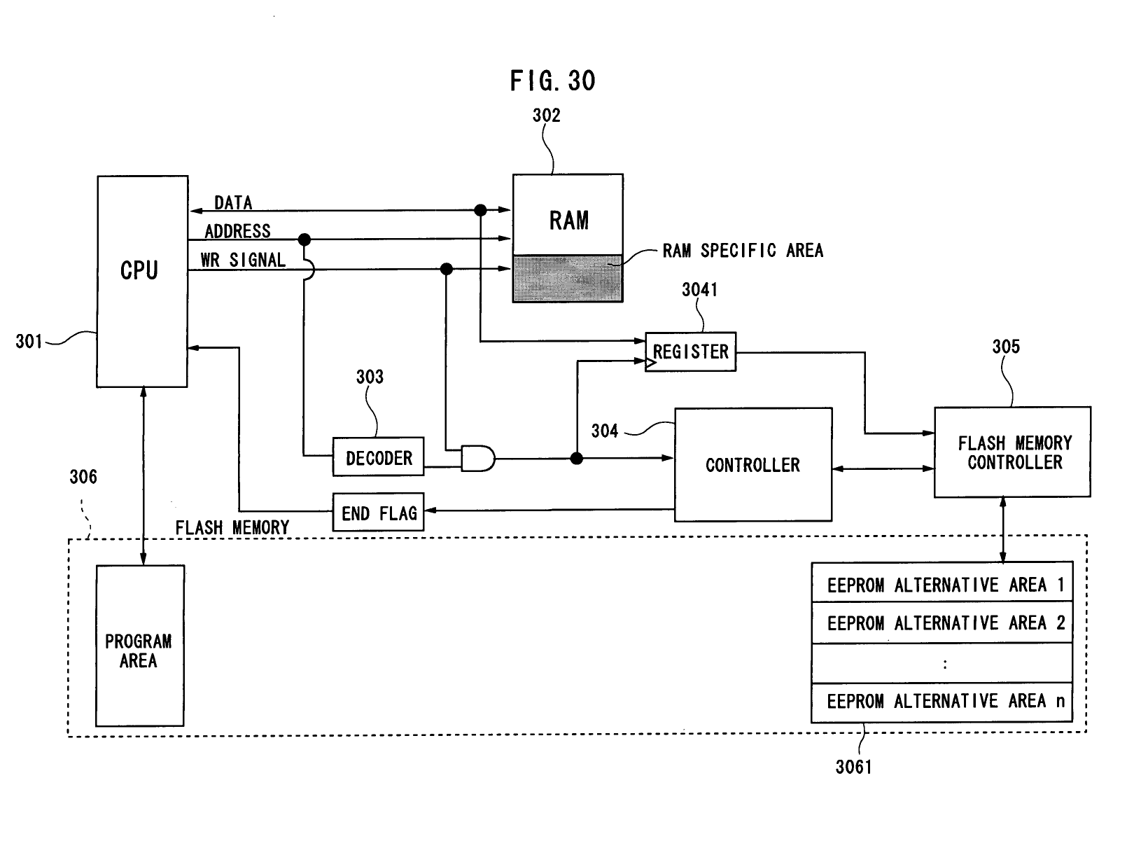

FIG. 30 is a block diagram of the eleventh embodiment.

A CPU 301 outputs data and activates a WR signal when writing data.

RAM 302 is single-port RAM. The RAM 302 stores data written by the CPU 301. The RAM 302 includes a specific area defined by a fixed address. The specific area may be defined by an address predetermined by a register and so on in a controller, which is described later.

A decoder 303 decodes a destination address when the CPU 301 activates the WR signal.

A controller 304 has a register 3041. The register 3041 reads the address decoded by the decoder 303 when the CPU 301 activates the WR signal and, if the address is in the specific area of the RAM 302, it latches the data stored in the specific area of the RAM 302. The register 3041 may be placed separately.

A flash memory controller 305 writes the user data read by the controller 304 to an EEPROM alternative area of flash memory, which is described later. A method of writing the user data to the EEPROM alternative area may be any method described in the first to sixth embodiments. The flash memory controller 305 further reads the data stored in the EEPROM area of the flash memory.

A flash memory 306 is divided into a program area for storing program and an EEPROM alternative area 3061 for storing data written to the specific area of the RAM 302.

A method of writing data in the above system is explained below.

When the CPU 301 activates the WR signal to the RAM 302, the decoder 303 decodes a destination address. If the destination address is in the specific area of the RAM 302, the register 3041 latches the data. Then, the controller 304 reads the data from the register 3041.

The flash memory controller 305 writes the data read by the controller 304 to the EEPROM alternative area 3061 of the flash memory 306. After that, the flash memory controller 305 sends a status to the controller 304.

Receiving the status, the controller 304 sets an end flag, thereby notifying the CPU 301 that data writing to the EEPROM area 3061 ends.

As described above, the system using the single-port RAM also allows rewriting data to the EEPROM alternative area 3061 of the flash memory 306 without occupying the resource of the CPU 301.

Embodiment 12

A twelfth embodiment of the present invention is explained hereinafter.

The eleventh embodiment explains the case of using the single-port RAM. However, since the above system writes data to the EEPROM alternative area each time user data is written to the specific area of the RAM, it shortens the life of the flash memory. The system of the present embodiment thus uses the single-port RAM and writes user data to the EEPROM area of the flash memory only when the CPU sets start trigger or upon interrupt from a peripheral macro.

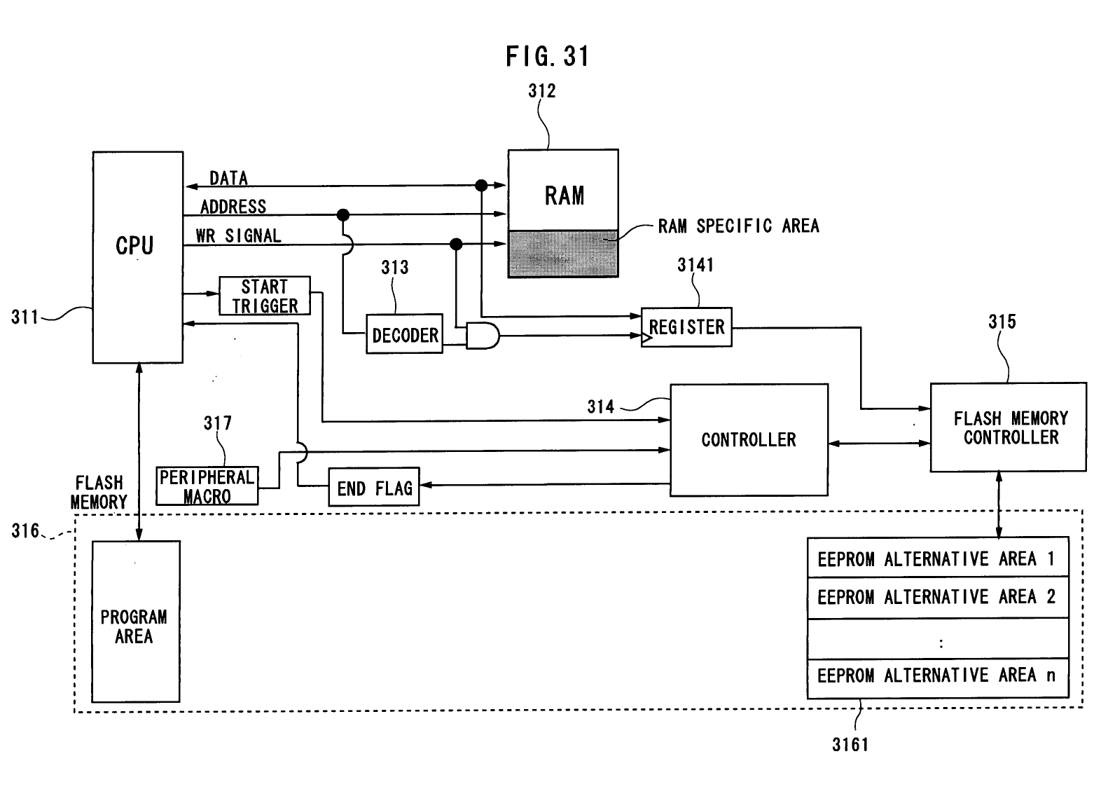

FIG. 31 is a block diagram of the twelfth embodiment.

A CPU 311 outputs data and activates a WR signal to write data. Further, the CPU 311 sets start trigger at a predetermined time such as at power-off.

RAM 312 is single-port RAM. The RAM 312 stores data written by the CPU 311. The RAM 312 includes a specific area defined by a fixed address. The specific area may be defined by an address predetermined by a register and so on in a controller, which is described later.

A decoder 313 decodes a destination address when the CPU 311 activates the WR signal.

A controller 314 has a register 3141. The register 3141 reads the address decoded by the decoder 313 when the CPU 311 activates the WR signal and, if the address is in the specific area of the RAM 312, it latches the data stored in the specific area of the RAM 312. The register 3141 may be placed separately.

The controller 314 reads the data stored in the register 3141 when CPU 311 sets start trigger or a peripheral macro, which is described later, sets interrupt trigger.

A flash memory controller 315 writes the user data read by the controller 314 to an EEPROM alternative area of flash memory. A method of writing the user data to the EEPROM alternative area may be any method described in the first to sixth embodiments. The flash memory controller 315 further reads the data stored in the EEPROM area of the flash memory.

A flash memory 316 is divided into a program area for storing program and an EEPROM alternative area 3161 for storing data written to the specific area of the RAM 312.

A peripheral macro 317 sets interrupt trigger at a predetermined time such as when a LVI macro detects battery voltage drop.

A method of writing data in the above system is explained below.

The CPU 311 activates the WR signal to the RAM 312 and writes data to the specific area of the RAM 312. The decoder 313 then decodes a destination address. If the destination address is in the specific area of the RAM 312, the register 3141 latches the data. Then, when the CPU 311 sets start trigger or the peripheral macro 317 sets interrupt trigger, the controller 314 reads the data from register 3141.

Then, the flash memory controller 315 writes the data read by the controller 314 to the EEPROM alternative area 3161 of the flash memory 316. After that, the flash memory controller 315 sends a status to the controller 314.

Receiving the status, the controller 314 sets an end flag, thereby notifying the CPU 311 that data writing to the EEPROM area 3161 ends.

Since the above system using the single-port RAM writes user data to the EEPROM area 3161 of the flash memory 316 only when it is necessary, such as when the CPU sets start trigger or upon interrupt from a peripheral macro, it is possible to extend the life of the flash memory.

Embodiment 13

A thirteenth embodiment of the present invention is explained hereinafter.

The thirteenth embodiment describes a system without RAM.

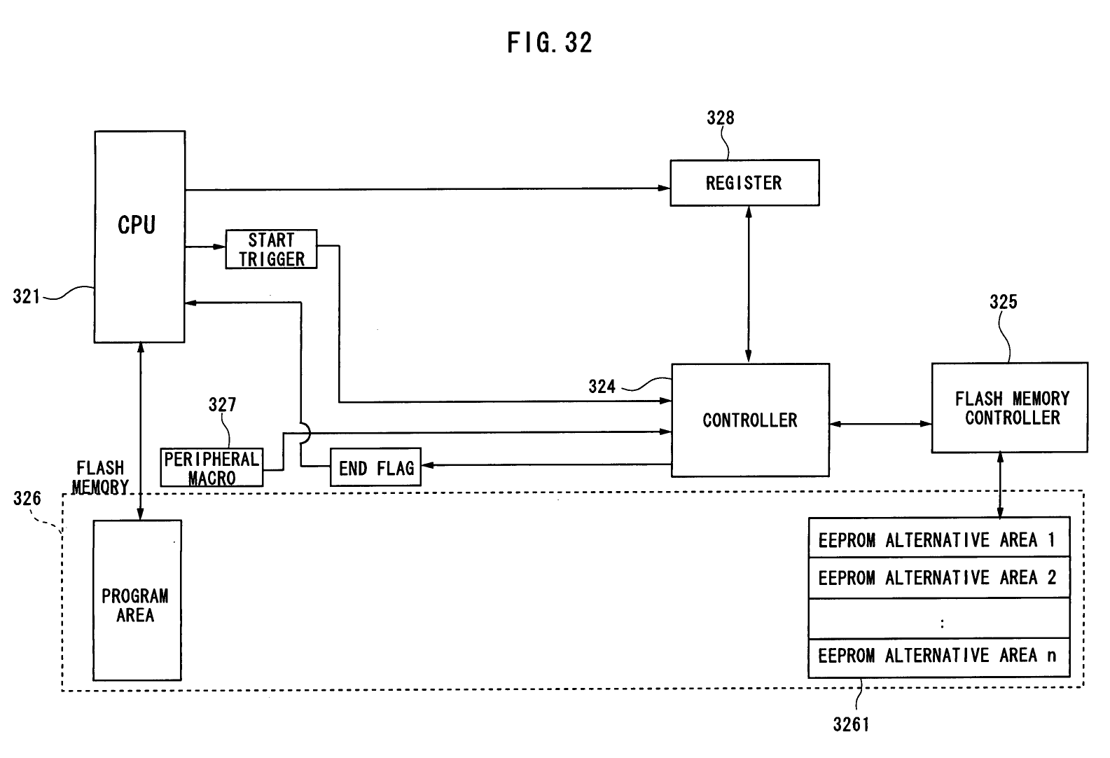

FIG. 32 is a block diagram of the thirteenth embodiment.

A CPU 321 outputs data and activates a WR signal when writing data. Further, the CPU 321 sets start trigger at a predetermined time such as at power-off.

A controller 324 reads data from a register, which is described later, when data is written to the register.

A flash memory controller 325 writes the user data read by the controller 324 to an EEPROM alternative area of flash memory. A method of writing the user data to the EEPROM alternative area may be any method described in the first to sixth embodiments.

A flash memory 326 is divided into a program area for storing program and an EEPROM alternative area 3261 for storing data written to the register.

A peripheral macro 327 sets interrupt trigger at a predetermined time such as when a LVI macro detects battery voltage drop.

A register 328 retains data written by the CPU 321.

A method of writing data in the above system is explained below.

The CPU 321 activates the WR signal to the register 328 and writes data to register 328. After that, the controller 324 reads the data from the register 328.

Then, the flash memory controller 325 writes the data read by the controller 324 to the EEPROM alternative area 3261 of the flash memory 326. After that, the flash memory controller 325 sends a status to the controller 324.

Receiving the status, the controller 324 sets an end flag, thereby notifying the CPU 321 that data writing to the EEPROM area 3261 ends.

Though the controller 324 reads data from the register 328 when the CPU 321 sets start trigger in the above-described operation, it may read data from the register 328 when the peripheral macro 327 sets interrupt trigger.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

1. A data read/write control system comprising:
memory divided into a plurality of blocks;
a write unit for, in writing data to one block of the plurality of blocks, comparing a size of the data with a capacity of a blank area of the block, and, if the size of the data is larger, the write unit erasing all data stored in the block and sequentially writing the data to the block from top or end; if the size of the data is smaller, the write unit sequentially writing the data to the block from an area next to an area where data is stored; and
a read unit for, in reading data from the block, sequentially searching the block from top or end for an area where data is written last and reading the data stored in the area.

2. The data read/write control system according to claim 1, wherein, in writing data to the block, the write unit further writes control data including information on reading of the data before or after the data.

3. A data read/write control system comprising:
memory divided into a plurality of blocks;
a control data storage unit for storing control data including information on reading of data stored in one block of the plurality of blocks;
a write unit for, in writing data to one block of the plurality of blocks, comparing a size of the data with a capacity of a blank area of the block, and, if the size of the data is larger, the write unit erasing all data stored in the block, sequentially writing the data to the block from top or end, and further writing control data of the written data to the control data storage unit; if the size of the data is smaller, the write unit sequentially writing the data to the block from an area next to an area where data is stored and further writing control data of the written data to the control data storage unit; and
a read unit for, in reading data from the block, sequentially searching the block for an area where data is written last based on the control data stored in the control data storage unit and reading the data stored in the area.

4. The data read/write control system according to claim 1, further comprising:
a switch unit for, when the write unit writes data to a block, switching a block from which the read unit is to read data to the block where the data is written.

5. The data read/write control system according to claim 3, further comprising:
a switch unit for, when the write unit writes data to a block, switching a block from which the read unit is to read data to the block where the data is written.

6. The data read/write control system according to claim 1, wherein, if a block becomes full with data, the write unit copies latest data written to the block to a different block and sets a flag indicating that the different block is a valid block for writing and reading data.

7. The data read/write control system according to claim 3, wherein, if a block becomes full with data, the write unit copies latest data written to the block to a different block and sets a flag indicating that the different block is a valid block for writing and reading data.

8. The data read/write control system according to claim 2, wherein the control data comprises a size of each data written to the block and/or a pointer indicating an address of data written next to each data.

9. The data read/write control system according to claim 3, wherein the control data comprises a size of each data written to the block and/or a pointer indicating an address of data written next to each data.

10. The data read/write control system according to claim 2, wherein the control data comprises an address of data written last to the block.

11. The data read/write control system according to claim 3, wherein the control data comprises an address of data written last to the block.

12. The data read/write control system according to claim 1, wherein the write unit verifies the block after writing data to the block.

13. The data read/write control system according to claim 3, wherein the write unit verifies the block after writing data to the block.

14. The data read/write control system according to claim 12, wherein, if the verification fails, the write unit overwrites data where the verification fails with data indicating error data.

15. The data read/write control system according to claim 13, wherein, if the verification fails, the write unit overwrites data where the verification fails with data indicating error data.

16. A data read/write control system comprising:
a temporary storage unit for temporarily storing data;
a central processing unit for writing data to the temporary storage unit;
memory divided into a plurality of blocks; and
a control unit having a write unit for, in writing data stored in the temporary storage unit to one block of the plurality of blocks, comparing a size of the data with a capacity of a blank area of the block, and, if the size of the data is larger, the write unit erasing all data stored in the block and sequentially writing the data to the block from top or end; if the size of the data is smaller, the write unit sequentially writing the data to the block from an area next to an area where data is stored; and a read unit for, in reading data from the block, sequentially searching the block from top or end for an area where data is written last and reading the data stored in the area.

17. The data read/write control system according to claim 16, wherein, each time data is written to the temporary storage unit, the write unit writes the data to the block.

18. The data read/write control system according to claim 16, wherein the write unit writes data stored in the temporary storage unit to the block upon satisfaction of a predetermined condition.

19. A data read/write control method for controlling data writing and reading in memory divided into a plurality of blocks, the method comprising:
writing data to one block of the plurality of blocks, including comparing a size of the data with a capacity of a blank area of the block, and, if the size of the data is larger, erasing all data stored in the block and sequentially writing the data to the block from top or end; if the size of the data is smaller, sequentially writing the data to the block from an area next to an area where data is stored; and
reading data from the block, including sequentially searching the block from top or end for an area where data is written last, and reading the data stored in the area.

20. The data read/write control method according to claim 19, wherein, in writing data to the block, control data including information on reading of the data is written before or after the data.

21. A data read/write control method for controlling data writing and reading in memory divided into a plurality of blocks and a control data storage unit for storing control data including information on reading of data stored in one block of the plurality of blocks, the method comprising:
writing data to one block of the plurality of blocks, including comparing a size of the data with a capacity of a blank area of the block, and, if the size of the data is larger, erasing all data stored in the block, sequentially writing the data to the block from top or end, and further writing control data of the written data to the control data storage unit; if the size of the data is smaller, sequentially writing the data to the block from an area next to an area where data is stored and further writing control data of the written data to the control data storage unit; and
reading data from the block, including sequentially searching the block for an area where data is written last based on the control data stored in the control data storage unit, and reading the data stored in the area.

22. The data read/write control method according to claim 19, further comprising predetermining a block where data is to be read, and, if data is written to a block different from the predetermined block, swapping the block where data is written and the block where data is to be read to avoid change in the block where data is to be read.

23. The data read/write control method according to claim 21, further comprising predetermining a block where data is to be read, and, if data is written to a block different from the predetermined block, swapping the block where data is written and the block where data is to be read to avoid change in the block where data is to be read.

24. The data read/write control method according to claim 19, further comprising, if a block becomes full with data, copying latest data written to the block to a different block, and setting a flag indicating that the different block is a valid block for writing and reading data.

25. The data read/write control method according to claim 21, further comprising, if a block becomes full with data, copying latest data written to the block to a different block, and setting a flag indicating that the different block is a valid block for writing and reading data.

26. The data read/write control method according to claim 19, wherein the control data comprises a size of each data written to the block and/or a pointer indicating an address of data written next to each data.

27. The data read/write control method according to claim 21, wherein the control data comprises a size of each data written to the block and/or a pointer indicating an address of data written next to each data.

28. The data read/write control method according to claim 19, wherein the control data comprises an address of data written last to the block.

29. The data read/write control method according to claim 21, wherein the control data comprises an address of data written last to the block.

30. The data read/write control method according to claim 19, further comprising verifying the block after writing data to the block.

31. The data read/write control method according to claim 21, further comprising verifying the block after writing data to the block.

32. The data read/write control method according to claim 30, further comprising, if the verification fails, overwriting data where the verification fails with data indicating error data.

33. The data read/write control method according to claim 31, further comprising, if the verification fails, overwriting data where the verification fails with data indicating error data.

34. A data read/write control method for controlling data writing and reading in a temporary storage unit for temporarily storing data and memory divided into a plurality of blocks, the method comprising:
writing data to the temporary storage unit;
writing data stored in the temporary storage unit to one block of the plurality of blocks, including comparing a size of the data with a capacity of a blank area of the block, and, if the size of the data is larger, erasing all data stored in the block and sequentially writing the data to the block from top or end; if the size of the data is smaller, sequentially writing the data to the block from an area next to an area where data is stored; and
reading data from the block, including sequentially searching the block from top or end for an area where data is written last, and reading the data stored in the area.

35. The data read/write control method according to claim 34, wherein, in writing data to one block of the plurality of blocks, data is written to the block each time the data is written to the temporary storage unit.

36. The data read/write control method according to claim 34, wherein, in writing data to one block of the plurality of blocks, data stored in the temporary storage unit is written to the block upon satisfaction of a predetermined condition.

37. Computer-readable media tangibly embodying a program of instructions executable by a computer to perform a method of controlling data writing and reading in a data read/write control system having memory divided into a plurality of blocks, the method comprising:
writing data to one block of the plurality of blocks, including comparing a size of the data with a capacity of a blank area of the block, and, if the size of the data is larger, erasing all data stored in the block and sequentially writing the data to the block from top or end; if the size of the data is smaller, sequentially writing the data to the block from an area next to an area where data is stored; and
reading data from the block, including sequentially searching the block from top or end for an area where data is written last, and reading the data stored in the area.

38. The computer-readable media according to claim 37, wherein in writing data to the block, control data including information on reading of the data is written before or after the data.

39. Computer-readable media tangibly embodying a program of instructions executable by a computer to perform a method of controlling data writing and reading in a data read/write control system having memory divided into a plurality of blocks and a control data storage unit for storing control data including information on reading of data stored in one block of the plurality of blocks, the method comprising:
writing data to one block of the plurality of blocks, including comparing a size of the data with a capacity of a blank area of the block and, if the size of the data is larger, erasing all data stored in the block, sequentially writing the data to the block from top or end, and further writing control data of the written data to the control data storage unit; if the size of the data is smaller, sequentially writing the data to the block from an area next to an area where data is stored, and further writing control data of the written data to the control data storage unit; and
reading data from the block, including sequentially searching the block for an area where data is written last based on the control data stored in the control data storage unit, and reading the data stored in the area.

40. The computer-readable media according to claim 37, wherein the method further comprises, upon writing of data to a block, switching a block from which the read unit is to read data to the block where the data is written.

41. The computer-readable media according to claim 37, wherein the method further comprises, if a block becomes full with data, copying latest data written to the block to a different block, and setting a flag indicating that the different block is a valid block for writing and reading data.

42. The computer-readable media according to claim 37, wherein the control data comprises a size of each data written to the block and/or a pointer indicating an address of data written next to each data.

43. The computer-readable media according to claim 37, wherein the control data comprises an address of data written last to the block.

44. The computer-readable media according to claim 37, wherein the method further comprises verifying the block after writing data to the block.

45. The computer-readable media according to claim 44, wherein the method further comprises, if the verification fails, overwriting data where the verification fails with data indicating error data.

46. Computer-readable media tangibly embodying a program of instructions executable by a computer to perform a method of controlling data writing and reading in a data read/write control system having a temporary storage unit for temporarily storing data and memory divided into a plurality of blocks, the method comprising:
writing data to the temporary storage unit;
writing data stored in the temporary storage unit to one block of the plurality of blocks, including comparing a size of the data with a capacity of a blank area of the block, and, if the size of the data is larger, erasing all data stored in the block and sequentially writing the data to the block from top or end; if the size of the data is smaller, sequentially writing the data to the block from an area next to an area where data is stored; and
reading data from the block, including sequentially searching the block from top or end for an area where data is written last, and reading the data stored in the area.

47. The computer-readable media according to claim 46, wherein, in writing data to one block of the plurality of blocks, data is written to the block each time data is written to the temporary storage unit.

48. The computer-readable media according to claim 37, in writing data to one block of the plurality of blocks, data stored in the temporary storage unit is written to the block upon satisfaction of a predetermined condition.
